(19) United States
(12) Patent Application Publication
(10) Pub. No.: US 2015/0006475 A1
(43) Pub. Date: Jan. 1, 2015

(54) DATA DEDUPLICATION IN A FILE SYSTEM

(71) Applicants: Katherine H. Guo, Scotch Plains, NJ (US); Thomas Woo, Short Hills, NJ (US)

(72) Inventors: Katherine H. Guo, Scotch Plains, NJ (US); Thomas Woo, Short Hills, NJ (US)

(21) Appl. No.: 13/927,180

(22) Filed: Jun. 26, 2013

(51) Int. Cl. G06F 17/30

(52) U.S. Cl. CPC G06F 17/30159
USPC 707/609; 707/693

(57) ABSTRACT

A data deduplication capability is presented. The data deduplication capability enables deduplication of data of a set of files, where the set of files may include files stored in network-based data storage elements and, optionally, files stored in one or more client devices which may communicate with the network-based data storage elements. The data deduplication capability may use one or more data deduplication techniques within files (for intra-file redundancy) or across files (for inter-file redundancy) in order to reduce or even minimize storage cost associated with storage of the files or bandwidth cost associated with transfers of the files. The data deduplication capability may use one or more data deduplication techniques in conjunction with one or more data compression techniques in order to reduce or even minimize storage cost associated with storage of the files or bandwidth cost associated with transfers of the files.

### TECHNICAL FIELD

The disclosure relates generally to network-based file systems and, more specifically but not exclusively, to reducing duplication of data in network-based file systems.

### BACKGROUND

The use of network-based data storage services, such as cloud-based storage services, to store data continues to increase. Additionally, as the data storage capabilities of mobile devices (e.g., smartphones, tablets, laptops, and the like) continue to increase, mobile devices also are increasingly being used as data storage devices. However, distribution of data in this manner tends to make the identification and elimination of redundant data more difficult.

### SUMMARY OF EMBODIMENTS

Various deficiencies in the prior art may be addressed by embodiments for reducing duplication of data in a file system.

In one embodiment, an apparatus includes a processor and a memory communicatively connected to the processor. The processor is configured to receive a file including original file contents, determine a set of data chunks of the original file contents of the file and a respective set of hash values of the data chunks, determine whether the data chunks are stored in a data chunk store including a set of data chunks for one or more stored files, encode the original file contents of the file, to form an encoded form of the original file contents of the file based on the hash values of the data chunks, compress the encoded form of the original file contents of the file to form a compressed form of the encoded form of the original file contents of the file, and store the compressed form of the encoded form of the original file contents of the file.

In one embodiment, a method includes using a processor and a memory for receiving a file including original file contents, determining a set of data chunks of the original file contents of the file and a respective set of hash values of the data chunks, determining whether the data chunks are stored in a data chunk store including a set of data chunks for one or more stored files, encoding the original file contents of the file to form an encoded form of the original file contents of the file based on the hash values of the data chunks, compressing the encoded form of the original file contents of the file to form a compressed form of the encoded form of the original file contents of the file, and storing the compressed form of the encoded form of the original file contents of the file.

In one embodiment, an apparatus includes a processor and a memory communicatively connected to the processor. The processor is configured to receive, from a data storage element, a file including metadata and file contents, where the file has original file contents associated therewith and where the original file contents include a set of data chunks. The processor is configured to, based on a determination that the file does not include a reference to a reference file including a form of the original file contents of the file, initiate a process to ensure that the set of data chunks of the original file contents of the file is present within a data chunk store including data chunks for one or more stored files.

In one embodiment, a method includes using a processor and a memory for performing a set of steps. The steps include receiving, from a data storage element, a file including metadata and file contents, where the file has original file contents associated therewith and where the original file contents include a set of data chunks. The steps include initiating, based on a determination that the file does not include a reference to a reference file including a form of the original file contents of the file, a process to ensure that the set of data chunks of the original file contents of the file is present within a data chunk store including data chunks for one or more stored files.

### BRIEF DESCRIPTION OF THE DRAWINGS

The teachings herein can be understood by considering the following detailed description in conjunction with the accompanying drawings, in which:

FIG. 1 depicts an exemplary communication system supporting embodiments of data deduplication for a set of files maintained by data storage elements;

FIG. 2 depicts an exemplary embodiment of a data storage element suitable for use as a data server or a client device of FIG. 1;

FIG. 3 depicts one embodiment of a method for performing data deduplication processing at a data storage element for a new file or an existing file in its original form;

FIG. 4 depicts one embodiment of a method for transferring a file from a source data storage element to a target data storage element using a file transfer and reference synchronization protocol;

FIG. 5 depicts one embodiment of a method for ensuring availability of data chunks of the original file contents of a file at a target data storage element;

FIG. 6 depicts one embodiment of a method for ensuring availability of data chunks of the original file contents of a file at a target data storage element;

FIG. 7 depicts one embodiment of a method for reconstructing a file using data chunks at a data storage element; and

FIG. 8 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

In general, a data deduplication capability is presented herein, although it will be appreciated that various other capabilities also may be presented herein. Various embodiments of the data deduplication capability enable deduplication of data of a set of files, where the set of files may include files stored in network-based data storage elements (e.g., as a network-based file system or network-based portion of a file system) and, optionally, files stored in one or more client devices which may communicate with the network-based data storage elements (e.g., as a local portion of a file system). Various embodiments of the data deduplication capability may use one or more data deduplication techniques within files (for intra-file redundancy) or across files (for inter-file redundancy) in order to reduce (or even minimize) storage cost associated with storage of the files or bandwidth cost associated with transfers of the files. Various embodiments of the data deduplication capability may use one or more data deduplication techniques in conjunction with one or more data compression techniques in order to reduce (or even minimize) storage cost associated with storage of the files or bandwidth cost associated with transfers of the files. Various embodiments of the data deduplication capability provide advantages such as reductions in storage costs, reductions in bandwidth costs during file uploads and downloads, reductions in data transfer latency due to reduced bandwidth usage, or the like.

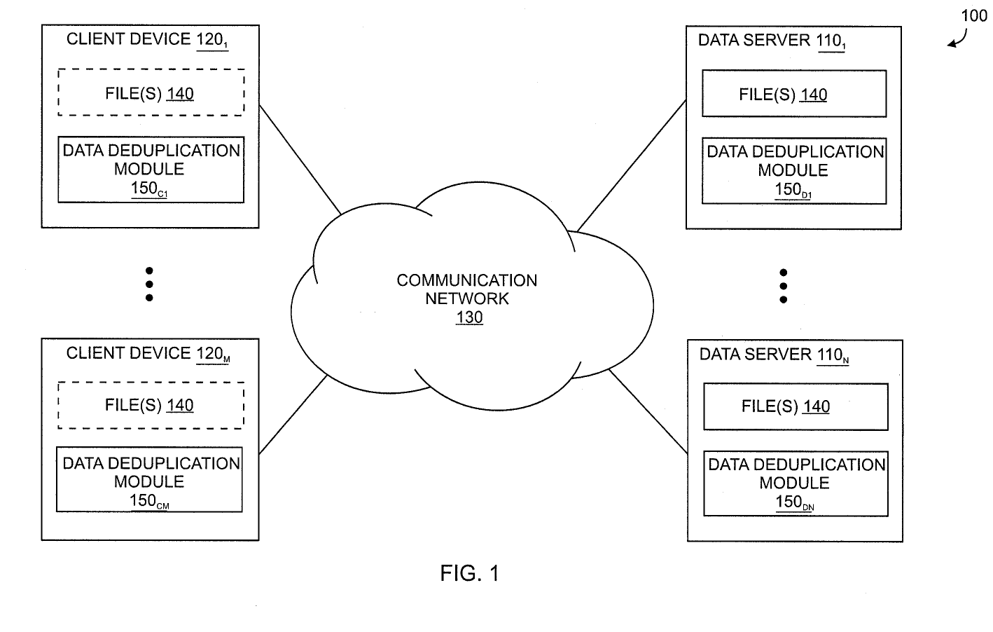

FIG. 1 depicts an exemplary communication system supporting embodiments of data deduplication for a set of files maintained by data storage elements.

The exemplary communication system 100 includes a plurality of data servers (DSs) 110₁-110_{N} (collectively, DSs 110), a plurality of client devices (CDs) 120₁-120_{M} (collectively, CDs 120), and a communication network (CN) 130.

The DSs 110 and CDs 120 provide data storage for a set of files 140, which may be referred to collectively as files 140. The storage of a file 140 includes storage of metadata of the file 140 and storage of file contents for the file 140.

The metadata of the file 140 may include the following information: (1) a file name of the file 140 (which also may include file path information indicative of the storage location of the file contents for the file 140), (2) the file size of the original file contents of the file 140, (3) the hash value computed for the original file contents of the file 140, and, optionally, (4) a reference (e.g., a pointer or other suitable type of file reference) to a reference file (e.g., another one of the files 140) for the file 140. The metadata of a file 140 may include less or more information.

The file contents of the file 140 may include: (1) the original file contents of the file 140 (not encoded or compressed), (2) an encoded form of the original file contents of the file 140 (encoded but not compressed), (3) a compressed, encoded form of the original file contents of the file 140, or (4) empty contents (NULL).

The original file contents of the file 140 (which also may be referred to as an original file 140 or original file contents) may include any suitable type of content. For example, the original file contents of the file 140 may include American Standard Code for Information Interchange (ASCII)-based content, binary content, or the like, as well as various combinations thereof. Thus, an original file 140 may include any suitable type of file, such as an ASCII-based file, a binary file (e.g., an audio file, an image file, a video file, a multimedia file, a Portable Document Format (PDF) file (e.g., an account statement, a receipt, or the like), an MICROSOFT WORD file, an executable file, or the like), or the like.

The original file contents of the file 140 may be encoded to form the encoded form of the original file contents of the file 140. The original file contents of the file 140 may be encoded to form the encoded form of the original file contents of the file 140 using any suitable type of encoding. In at least some embodiments, the original file contents of the file 140 may be encoded based on data chunks (e.g., including one or more pointers to one or more (possibly compressed) data chunks). In at least some embodiments, the pointers to data chunks may include hash values of the data chunks, where the data chunks have been removed from the original file contents of the file 140 and the hash values of the data chunks have been inserted into the original file contents of the file 140 to form thereby the encoded form of the original file contents of the file 140.

The encoded form of the original file contents of the file 140 may be compressed to form the compressed, encoded form of the original file contents of the file 140. The encoded form of the original file contents of the file 140 may be compressed to form the compressed, encoded form of the original file contents of the file 140 using any suitable type of compression. In at least some embodiments, compression may be performed base based on the LZ77 or LZ78 algorithms or their variations (e.g., Lempel-Ziv-Welch (LZW), Lempel-Ziv-Storer-Szymanski (LZSS), Lempel-Ziv-Markov chain algorithm (LZMA), or the like), the Burrows-Wheeler algorithm, or the like.

It will be appreciated that, in at least some embodiments, when the metadata of the file 140 does not include a reference to a reference file, the file contents of the file 140 includes some form of the original file contents of the file 140 (e.g., the original file contents, the encoded form of the original file contents, the compressed, encoded form of the original file contents, or the like). Similarly, it will be appreciated that, in at least some embodiments, when the metadata of the file 140 includes a reference to a reference file, the file contents of the file 140 is empty.

It will be appreciated that, although primarily depicted and described herein with respect to embodiments in which, when a file 140 references a reference file, the reference to the reference file is maintained as part of the metadata of the file 140 and the file contents of the file 140 is empty, in at least some embodiments the reference to the reference file may be maintained as the file contents of the file 140 rather than as part of the metadata of the file 140 (and, thus, that the file contents of the file 140 is not empty, but, rather, includes information adapted for use in obtaining a form of the original file contents of the file 140).

Thus, it will be appreciated that storage of the given file 140 includes a form of the original file contents of the file, information configured for use in obtaining a form of the original file contents of the file, or the like, as well as various combinations thereof.

In at least some embodiments, different files 140 including or referencing the same original file contents (e.g., the same text document, the same song, the same video, the same PDF document, or the like) may include different associated metadata (e.g., different file names, different file path information, or the like). In at least some embodiments, where multiple files 140 include, represent, or reference the same original file contents, the multiple files 140 may have unique metadata associated therewith, respectively.

In at least some embodiments, the file name of a file 140 may be configured to indicate the storage location of the file contents of the file 140 and the form in which the original file contents of the file 140 are stored (e.g., original, encoded but not compressed, encoded and compressed, or the like). The file name of a file 140 may be implemented in any suitable manner (e.g., as a file name without using extensions, as a file name plus one or more extensions, or using any other suitable file naming convention(s)). The file name of a file 140 may be used to retrieve the file contents of the file 140. For example, if the original file contents of a file are stored in three forms (namely, as the original file contents, as an encoded form of the original file contents, and as a compressed and encoded form of the original file contents), then three files 140 having three file names may be used to identify the three forms of the file contents of the file 140. For example, for a file f1.pdf, file names of f1.pdf, f1.pdf.enc, and f1.pdf.enc.cpr may be used for the original file contents, the encoded form of the original file contents, and the compressed and encoded form of the original file contents. It will be appreciated that, while the same file naming convention may be used by elements of the exemplary communication system 100, it is not necessary that elements of exemplary communication system 100 use the same file naming convention as long as each element is aware of its own file naming convention and, thus, can distinguish between different forms of the original file contents of files 140.

The files 140 are accessible to a set of users which may interact with and manage the files 140 via CDs 120. The set of users of the files 140 may include one or more users (e.g., one or more individual users, one or more employees of an enterprise, one or more members of an organization, or the like). For purposes of clarity, the set of users of the files 140 is primarily referred to herein as a user of the files 140.

It will be appreciated that the files 140 may be a subset of a full set of files of the set of users, a subset of the full set of files of the set of users that is subject to embodiments of the data deduplication capability (which may in turn be a subset of the full set of files of the set of users), or any other suitable type of subset.

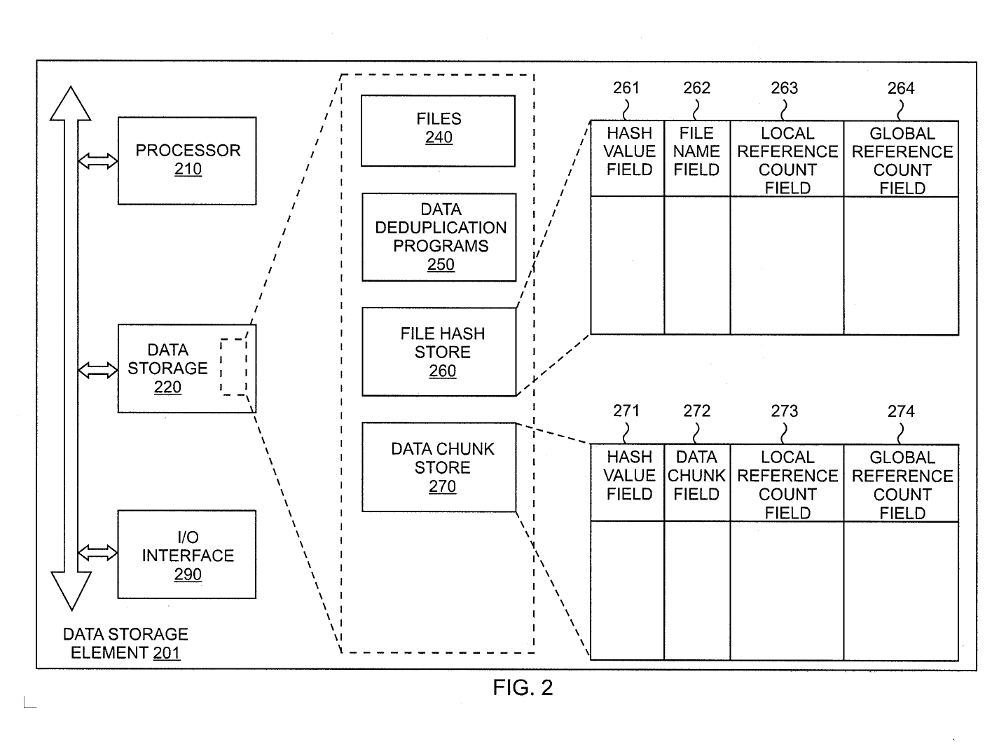

The DSs 110 and CDs 120 which store files 140 may be referred to collectively as data storage elements (or as data processing elements, given that the elements are expected to include processing capabilities for use in managing storage of the files 140). An exemplary data storage element suitable for use as a DS 110 or a CD 120 is depicted and described with respect to FIG. 2.

The DSs 110 provide network-based storage of files 140. The files 140 stored by DSs 110 may be referred to as a network-based file system, or as a network-based portion of a file system (e.g., where at least some files 140 are stored locally by one or more CDs 110). The DSs 110 may be dedicated data servers (e.g., dedicated network-based data servers, dedicated data servers in one or more data centers, or the like), virtual data servers in a cloud-based environment (e.g., virtual data servers of a single data center, virtual data servers of multiple distributed data centers, or the like), or the like, as well as various combinations thereof. The DSs 110, when implemented as virtual data servers in a cloud-based environment, may be provided using a single cloud-based service of a cloud server provider, multiple cloud-based services of a cloud service provider, multiple cloud-based services of multiple cloud service providers, or the like. The DSs 110 may access CN 130 in any suitable manner. The DSs 110 may be a subset of the full set of data servers providing network-based storage of files 140 of the set of users. The DSs 110 may be a subset of the full set of data servers available to provide network-based storage of files 140 of the set of users.

The CDs 120 include devices configured to provide local storage of files 140 and to support interaction with files 140 that are stored by DSs 110. The CDs 120 may interact with files 140 that are stored by DSs 110 by accessing files 140 that are maintained on DSs 110, modifying files 140 that are maintained on DSs 110, writing new files 140 to DSs 110, deleting existing files from DSs 110, or the like, as well as various combinations thereof. The CDs 120 may be used by a set of users permitted to interact with the files 140; although, as noted above, for purposes of clarity the set of users permitted to interact with the files 140 is primarily referred to herein as a user of the files 140. For example, CDs 120 may include one or more of a desktop computer(s), a laptop computer(s), a tablet computer(s), a smartphone(s), an e-reader(s), or the like. The CDs 120 may access CN 130 in any suitable manner, e.g., using one or more wired connections (e.g., cable, DSL, optical fiber, or the like) between a CD 120 and CN 130, using one or more wireless connections (e.g., Wireless Fidelity (WiFi), Universal Mobile Telecommunication System (UMTS), Long Term Evolution (LTE), or the like) between a CD 120 and CN 130, or the like, as well as various combinations thereof.

The DSs 110₁-110_{N} include a plurality of data deduplication modules 150_{D1}-150_{DN} (collectively, data deduplication modules 150_{D}) and, similarly, the CDs 120₁-120_{M} include a plurality of data deduplication modules 150_{C1}-150_{CM} (collectively, data deduplication modules 150_{C}). The data deduplication modules 150_{D} of the DSs 110 and the data deduplication modules 150_{C} of the CDs 120 may be referred to collectively as data deduplication modules 150. In general, a data deduplication module 150 is configured to identify and eliminate duplicated data of the original file contents of the files 140, which may include identification and deduplication of intra-file redundancy or inter-file redundancy. A data deduplication module 150 may include various modules, programs, reference information, or the like, at least some embodiments of which are depicted and described with respect to the exemplary data storage element of FIG. 2.

The CN 130 includes one or more networks configured to support various types of communications related to management of the files 140. For example, CN 130 may support communications between DSs 110 and CDs 120, communications between DSs 110, communications between CSs 120, communications between DSs 110 and other elements, communications between CDs 120 and other elements, or the like, as well as various combinations thereof. For example, CN 130 may support communications related to interaction by CDs 120 with files 140 stored on DSs 110, transfers of files 140, or the like. For example, CN 130 may include one or more local networks, one or more data center networks, one or more access networks (e.g., supporting network access by DSs 110, supporting network access by CDs 120, and the like), one or more core networks, or the like, as well as various combinations thereof. Accordingly, it will be appreciated that CN 130 may include various types of communications technologies and capabilities (e.g., cable, DSL, WiFi, UMTS, LTE, IP networking, or the like, as well as various combinations thereof) which may be provided using various devices, elements, functions, links, or the like, as well as various combinations thereof.

FIG. 2 depicts an exemplary embodiment of a data storage element suitable for use as a data server or a client device of FIG. 1.

The data storage element 201 includes a processor 210, a data storage 220, and an input/output (I/O) interface 290.

The processor 210 controls the operation of data storage element 201. The processor 210 cooperates with data storage 220 and I/O interface 290 to provide various functions of data storage elements as depicted and described herein.

The data storage 220 stores files 240, data deduplication programs 250, a file hash store 260, and a data chunk store 270. The data storage 220 may store various other types of programs, data, or the like.

The files 240 may include one or more files 140 of the user. The storage of a file 240 in data storage 220 has been described with respect to storage of a file 140 in FIG. 1. It will be appreciated that less or more information may be stored for some or all of the files 240. It also will be appreciated that the storage of the files 240 in data storage 220 may depend on one or more factors, such as the type of data storage element 201 (e.g., DS 110 versus CD 120), implementation of the DS 110 where the data storage element 201 is a DS 110, or the like, as well as various combinations thereof. It also will be appreciated that one or more of the files 240 may be stored in one or more storage elements other than data storage 220 (e.g., one or more storage elements internal to or external to but accessible by the data storage element 201).

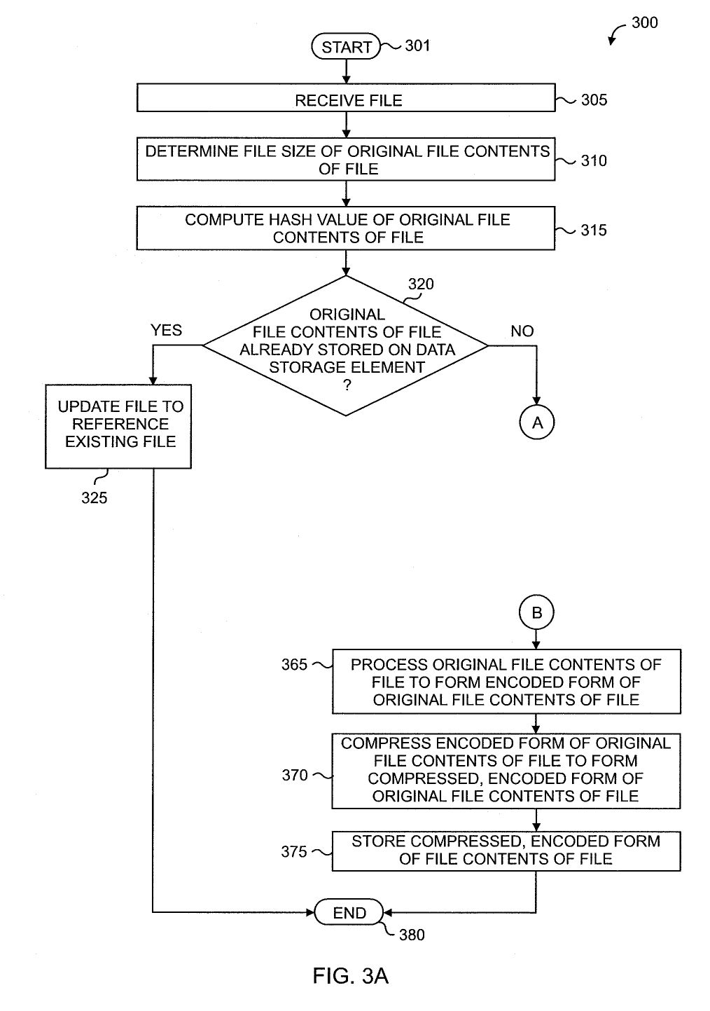

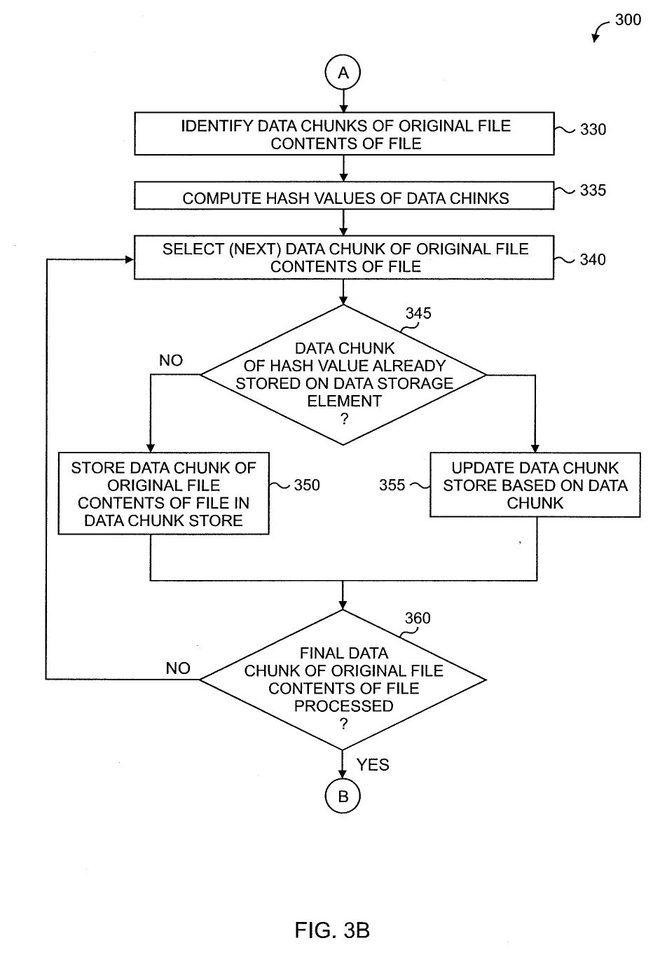

The data deduplication programs 250 include programs configured to be executed by processor 210 in order to provide various functions of the data deduplication capability. The data deduplication programs 250 may include one or more file processing programs for processing files 240 received at the data storage element 201 (e.g., such as the method depicted and described with respect to FIG. 3), one or more data chunking programs for dividing the original file contents of files 240 into data chunks, one or more hashing programs or functions (e.g., for computing hashes of the original file contents of files 240, hashes of data chunks of the original file contents of files 240, or the like), one or more file compression programs (e.g., for compressing the original file contents of files 240, for compressing the encoded forms of the original file contents of files 240, for compressing data chunks of the original file contents of files 240, or the like), one or more file transfer and reference synchronization programs, one or more data deletion/cleanup programs, or the like, as well as various combinations thereof. It will be appreciated that at least some such processes are depicted and described with respect to FIGS. 3-7.

The one or more data chunking programs may include any data chunking program(s) suitable for use in performing data chunking of original file contents of a file 240.

In at least some embodiments, a sliding-window-based data chunking program is provided. In at least some embodiments, the sliding-window-based data chunking program may be configured to divide the original file contents of a file 240 into a mixture of data chunks of variable sizes. The sliding window is used to determine data chunk boundaries. In general, a data chunk boundary is selected based on the value of the hash function that is applied to the sliding window, such that the original file contents of the file 240 determines the chunking boundary and similar chunks can be identified even if a small insertion is applied to the original file contents of the file 240 disrupting the data chunk boundary of the original file contents of the file 240. In general, a data chunk is between two data chunk boundaries and is of variable size. It is noted that, given that the value of the hash function that is used for data chunking may not be able to guarantee chunk sizes, minimum and maximum data chunk sizes may be forced and the following rules may be used: (1) if the current chunk size is smaller than the minimum chunk size value, then the current chunk boundary is skipped, and the next chunk boundary is used as the ending position for the current data chunk and (2) if the current chunk size is larger than the maximum value, then a new chunk boundary is forced such that the current chunk size is the maximum chunk size.

In at least some embodiments, a fixed-boundary data chunking program is provided. The fixed-boundary data chunking program may be configured to divide the original file contents of a file 240 using a fixed boundary, such that there is no need to calculate the hash value of a sliding window of data bytes.

In at least some embodiments, data chunks are defined by physical layer constraints (e.g., 4 KB-128 KB block sizes in file systems, such as where the data storage element 201 is a DS 110 that is implemented as a virtual data server in a cloud-based environment).

The one or more hashing programs or hashing functions may include any programs or functions suitable for use in computing hashes of the original file contents of files 240 or computing hashes of data chunks of the original file contents of files 240. For example, an MD5 hash function may be used to calculate hash values for the original file contents of the files 240 or for data chunks of the original file contents of the files 240.

The one or more data compression programs may include any data compression program(s) suitable for use in compressing original file contents of a file 240 or compressing data chunks of the original file contents of a file 240. The compression of the original file contents of a file 240 may include compressing the original file contents of the file 240 directly (e.g., where the original file contents of the file 240 are not encoded) or compressing an encoded form of the original file contents of the file 240 (e.g., encoded, based on data chunking, using one or more data chunks). The compression of a data chunk of the original file contents of a file 240 may include applying data compression to the data chunk. For example, the data compression program(s) may include the LZ77 or LZ78 algorithms or their variations (e.g., LZW, LZSS, LZMA, or the like). For example, the data compression program(s) may include the Burrows-Wheeler algorithm and the open source file compressor bzip2 based on the Burrows-Wheeler algorithm. The data compression program(s) may be applied to the original file contents of a file 240 (or to the encoded form of the original file contents of a file 240) in order to identify short repeated substrings within the original file contents of the file 240 (or to the encoded form of the original file contents of a file 240) and to include, within the compressed form of the original file contents of the file 240 (or the compressed form of the encoded form of the original file contents of a file 240), dictionaries that provide the mappings between the substrings and the associated codes. The data compression program(s) may be applied to a data chunk of the original file contents of a file 240 in order to identify short repeated substrings inside the data chunk of the original file contents of the file 240 and to include, within the compressed form of the data chunk of the original file contents of the file 240, dictionaries that provide the mappings between the substrings and the associated codes. Thus, it will be appreciated that multiple levels of compression may be applied to the original file contents of a file 240 (e.g., compression at the data chunk level as well as at the file level).

The file hash store 260 is a hash table including entries for the files 240 stored on the data storage element 201, respectively. The file hash store 260 includes a hash value field 261, a file name field 262, a local reference count field 263, and a global reference count field 264. The hash value field 261, for a given file 240, includes a hash value of the original file contents of the file 240. The file name field 262, for a given file 240, includes a file name of the file 240. The local reference count field 263, for a given file 240, includes a value indicative of the total number of files 240 stored locally on the data storage element 201 that include a reference to the given file 240. The global reference count field 264, for a given file 240, includes a value indicative of the total number of files 240 stored globally on the data storage elements 201 that refer to the given file 240. It will be appreciated that file hash store 260 may include less or more information, and that the information of file hash store 260 may be arranged in any other suitable manner. The use of the file hash store 260 to support data deduplication for files 240 is described in additional detail below.

The data chunk store 270 is a hash table including entries for data chunks of files 240 stored on the data storage element 201, respectively. The data chunk store 270 includes a hash value field 271, a data chunk field 272, a local reference count field 273, and a global reference count field 274. The hash value field 271, for a given data chunk, includes a hash value of the data chunk. The data chunk field 272, for a given data chunk, includes the data chunk (which may be stored in an uncompressed or compressed format) or a pointer to a storage location of the data chunk. The local reference count field 273, for a given data chunk, includes a value indicative of the total number of files 240 stored locally on the data storage element 201 that refer to the data chunk or a value indicative of the number of times that the data chunk is referenced by files 240 stored locally on the data storage element 201. The global reference count field 274, for a given data chunk, includes a value indicative of the total number of files 240 stored globally on the data storage elements 201 that refer to the data chunk or a value indicative of the number of times that the data chunk is referenced by files 240 stored globally on the data storage elements 201. It will be appreciated that data chunk store 270 may include less or more information, and that the information of data chunk store 270 may be arranged in any other suitable manner. The use of the data chunk store 270 to support data deduplication for files 240 is described in additional detail below.

The data storage 220 may include various types of local storage capabilities for the data storage element 201. The data storage 220 may include one or more memory modules, one or more disks, or the like, as well as various combinations thereof. For example, various programs (e.g., data deduplication programs 250) may be stored in memory for execution by processor 210. For example, various types of data which may be processed by processor 210 (e.g., files 240, file hash store 260, data chunk store 270, or the like) may be stored in memory, stored in disk and moved to memory for processing by processor 210, or the like, as well as various combinations thereof.

In at least some embodiments, the various data storage elements 201 may support use of at least some of the same functions and parameters. In at least some embodiments, various parameters and hash functions may be configured as follows: (1) parameter C is the same on each of the data storage elements 201, (2) the hash function used to compute hash values for the original file contents of files 240 is the same on each of the data storage elements 201, (3) the hash function used to identify boundaries for data chunks of the original file contents of files 240 (e.g., if a sliding-window based data chunking mechanism is used for data chunking of files) is the same on each of the data storage elements 201, and (4) the hash function used to compute hash values for data chunks of the original file contents of files 240 is the same on each of the data storage elements 201. In at least some embodiments, use of these same functions and parameters on the various data storage elements 201 may minimize bandwidth usage during file transfers between the data storage elements 201. It will be appreciated that, although hash functions used for the same purpose on different data storage elements are the same, different hash functions may be used by the data storage elements 201 for different purposes (e.g., the hash function used by the data storage elements to compute hash values for the original file contents of files 240 may be different than the hash function used by the data storage elements to compute hash values in order to identify boundaries for data chunks of the original file contents of files 240). It will be appreciated that, since file compression techniques generally are self-contained, there is no need to place restrictions on file compression techniques applied to different files 240 or data chunks of files 240 at the various data storage elements 201.

The I/O interface 290 provides an interface to CN 130. The I/O interface 290 is configured to cooperate with processor 210 to support communications via CN 130.

It will be appreciated that data storage element 201 also may include various other types of modules and capabilities, which may depend on the type of data storage module being implemented (e.g., DS 110 versus CD 120). For example, where data storage module 201 is an implementation of a DS 110 of FIG. 1, data storage module 201 may include server blades, may be implemented on a host computer within a data center, or the like. For example, where data storage module 201 is an implementation of a DS 110 of FIG. 1, data storage module 201 may include one or more video presentation interfaces, one or more audio presentation interfaces, one or more content capture interfaces, or the like, as well as various combinations thereof.

Referring back to FIG. 1, it will be appreciated that, given that any of the DSs 110 or the CDs 120 of the communication system 100 may be implemented as a data storage element 201 of FIG. 2, reference may be made herein to data storage elements 201 of communication system 100 of FIG. 1. It will be appreciated that at least some portions of a data storage element 201 (e.g., components, elements, modules, programs, data, reference information, or the like) may be considered to provide the data deduplication module 150 of the data storage element 201 (e.g., the data deduplication module 150 of the DS 110 or the CD 120 implemented as data storage element 201).

In various embodiments, management of files 140 may rely upon various types of file transfers of files 140. For example, management of files 140 may utilize transfer of files 140 to data storage elements 201, from data storage elements 201, between data storage elements 201, or the like, as well as various combinations thereof. For example, at least the following types of file transfers may be supported by data storage elements 201 such that the data storage elements 201 may support management of the files 140:

(1) direct storage of a file into network-based storage (e.g. one of the DSs 110) from another source (e.g., a website, a content server, or the like), without appearing on any of CDs 120 of the user;

(2) direct downloading of a file into a CD 120 of the user from an external source (e.g., a website, a content server, or the like);

(3) uploading of a file from a CD 120 of the user into network-based storage (e.g., one of the DSs 110);

(4) downloading of a file from network-based storage (e.g. one of the DSs 110) into a CD 120 of the user;

(5) transferring a file directly from one CD 120 of the user to another CD 120 of the user; and

(6) transferring a file directly from one DS 110 of the user to another DS 110 of the user.

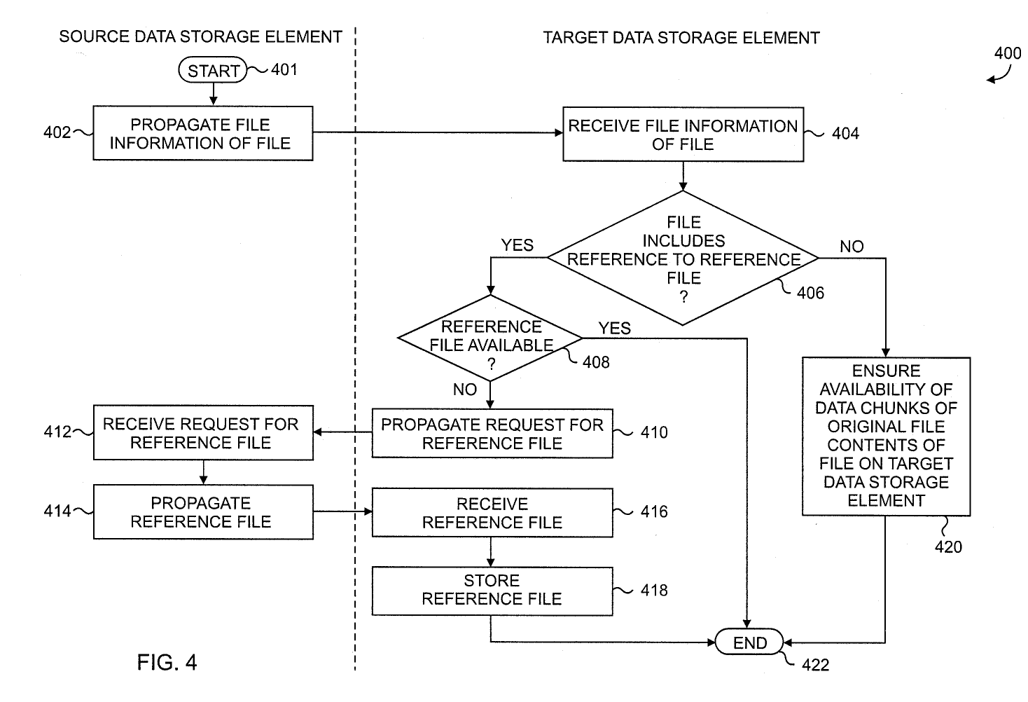

In at least some embodiments, a file 240 that is transferred to a data storage element 201 may be a new file 240 which may be processed in a manner for reducing data redundancy (e.g., as depicted and described with respect to FIG. 3). In at least some embodiments, an existing file 240 that is transferred from a source data storage element 201 to a target data storage element 201 may be processed in a manner that tends to maintain reduction of data redundancy (e.g., as depicted and described with respect to FIGS. 4-6). In at least some embodiments, the data deduplication capability is configured to perform a file transfer for a data storage element(s) 201 in a manner tending to reduce (and potentially minimize) storage space on the data storage element(s) 201 and reduce (and potentially minimize) bandwidth usage for the data transfer for the data storage element(s) 201. In at least some embodiments, the data deduplication capability is configured to balance processing costs with the goals of reducing (and potentially minimizing) storage space on the data storage element(s) 201 and reducing (and potentially minimizing) bandwidth usage for data transfers of the data storage element(s) 201.

In at least some embodiments, a file may be transferred to a data storage element 201 (e.g., to a DS 110, to a CD 120, or the like) for storage as a file 240. As discussed above, a file may be transferred to a data storage element 201 for various reasons. An exemplary embodiment for processing of a file at a data storage element 201 is depicted and described with respect to FIG. 3.

FIG. 3 depicts one embodiment of a method for performing data deduplication processing at a data storage element for a new file or an existing file in its original form. It will be appreciated that the data storage element may be a DS 110, a CD 120, or any other suitable type of data storage element. It will be appreciated that, although primarily depicted and described as being performed serially, at least a portion of the steps of method 300 may be performed contemporaneously, or in a different order than depicted and described with respect to FIG. 3.

At step 301, method 300 begins.

At step 305, a file is received at the data storage element. The file has metadata associated therewith (e.g., a file name of the file, a file size of the original file contents of the file, or the like). The file contents of the file are the original file contents of the file (in an uncompressed and unencoded form). The file may be received in accordance with any of the transfer scenarios discussed above. For example, the file may be a new file not currently stored by any of data storage elements, an existing file that is stored by one of the data storage elements but for which data deduplication processing has not yet been performed, or the like.

At step 310, a file size of the original file contents of the file is determined.

At step 315, a hash value of the original file contents of the file is computed. The hash value of the original file contents of the file may be computed using any suitable type of hash function.

At step 320, a determination is made as to whether the original file contents of the file are already stored on the data storage element. This also may be referred to herein as a determination as to whether the original file contents of the file are stored locally (e.g., the data storage element on which method 300 is executed determines whether the original file contents of the file are stored locally in any memory or disk of that data storage element, as opposed to on some other data storage element). If the original file contents of the file are already stored on the data storage element, method 300 proceeds to step 325. If the original file contents of the file are not already stored on the data storage element, method 300 proceeds to step 330.

The determination as to whether the original file contents of the file are already stored on the data storage element may be based on at least one of the file size of the original file contents of the file (which also may be referred to herein as the file size of the file) or the hash value of the original file contents of the file (which also may be referred to herein as the hash value of the file).

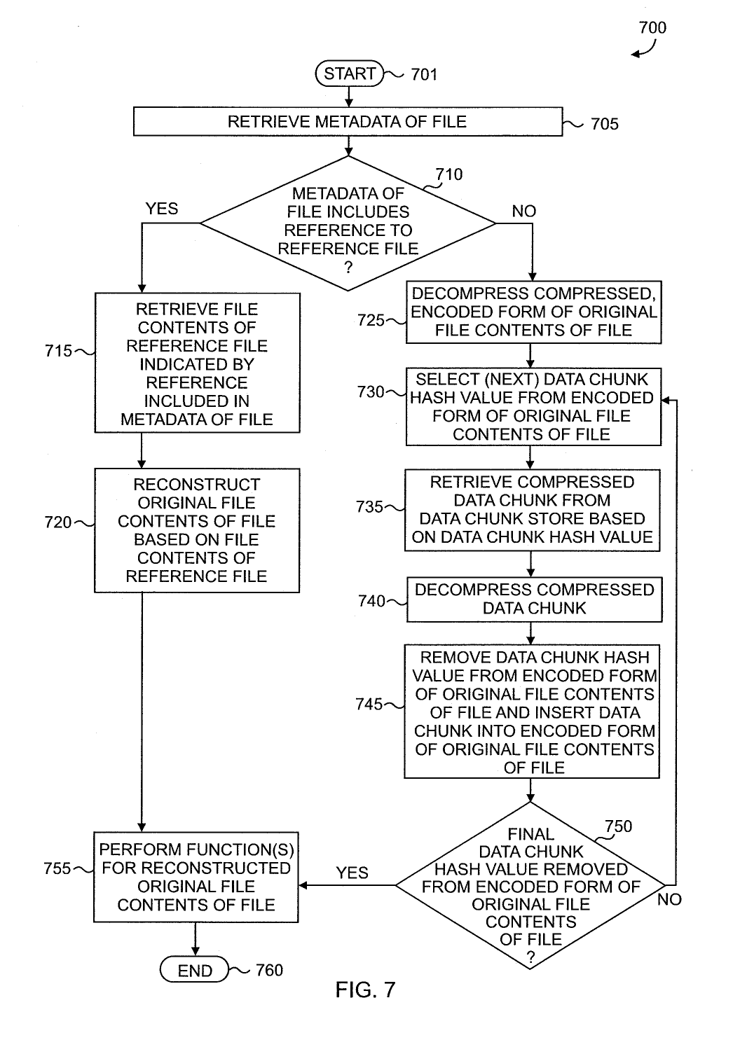

In at least some embodiments, for example, the determination as to whether the original file contents of the file are already stored on the data storage element may be performed as follows. The file size of the original file contents of the file is compared to file sizes of existing files stored on the data storage element. If none of the existing files stored on the data storage element has a file size matching the file size of the original file contents of the file, then a determination is made that the original file contents of the file are not stored on the data storage element. If one of the existing files stored on the data storage element has a file size matching the file size of the original file contents of the file, the hash value of the original file contents of the file is compared with a hash value of the existing file having the matching file size. If the hash values of the original file contents of the file and the existing file do not match, then the files are different. If the hash value of the original file contents of the file does not match any hash values of any existing files having file sizes that match the file size of the original file contents of the file, then a determination is made that the original file contents of the file are not stored on the data storage element. If the hash value of the original file contents of the file matches a hash value of one of the existing files (where the two files also have matching file sizes), then a byte-by-byte comparison is performed to determine whether the original file contents of the file are identical to the original file contents of the file having the matching file size and hash value. It will be appreciated that, since the existing file is expected to include a compressed, encoded form of the original file contents of the existing file, the original file contents of the existing file may need to be reconstructed in order for the byte-by-byte comparison to be performed. An exemplary embodiment for reconstructing the original file contents of a file from a compressed, encoded form of the original file contents of the file is depicted and described with respect to FIG. 7. If the byte-by-byte comparison indicates that the original file contents of the file and the original file contents of the existing file are identical, a determination is made that the original file contents of the file are already stored on the data storage element. If the byte-by-byte comparison indicates that the original file contents of the file and the original file contents of the existing file are different, then a determination is made that the original file contents of the file are not stored on the data storage element.

At step 325, the file is updated to reference the existing file (e.g., using a pointer or other suitable form of referencing the existing file). The file may be updated by adding a reference to the existing file to the metadata of the file and deleting the original file contents of the file (i.e., the file contents of the file is empty after being updated). The file may be updated by deleting the file contents of the file and adding a reference to the existing file as the file contents of the file (rather than adding the reference to the metadata of the file). From step 325, method 300 proceeds to step 380, where method 300 ends.

At step 330, data chunks of the original file contents of the file are identified. In at least some embodiments, the data chunks of the original file contents of the file may be identified by diving the original file contents of the file into data chunks using a data chunking mechanism. It will be appreciated that any suitable data chunking mechanism may be used to divide the original file contents of the file into data chunks (e.g., a sliding-window based data chunking mechanism, a data chunking mechanism using a fixed boundary, or the like).

At step 335, hash values are computed for the data chunks. The hash values of the respective data chunks may be computed using any suitable hash function(s).

At step 340, a (next) hash value of a data chunk of the original file contents of the file is selected.

At step 345, a determination is made as to whether the data chunk associated with the hash value is already stored on the data storage element. If a determination is made that the data chunk associated with the hash value is not already stored on the data storage element, method 300 proceeds to step 350. If a determination is made that the data chunk associated with the hash value is already stored on the data storage element, method 300 proceeds to step 355.

The determination as to whether the data chunk associated with the hash value is already stored on the data storage element may be performed by searching the data chunk store of the data storage element based on the hash value of the data chunk. If no matching entry is identified in the data chunk store (e.g., no entry of the data chunk store has a hash value that matches the hash value of the selected data chunk of the original file contents of the file), a determination is made that the data chunk associated with the hash value is not already stored on the data storage element. If a matching entry is identified in the data chunk store (e.g., an entry of the data chunk store having a hash value that matches the hash value of the selected data chunk of the original file contents of the file), a determination may be made that the data chunk associated with the hash value is already stored on the data storage element, or additional processing may be performed in order to confirm that the data chunk associated with the hash value is already stored on the data storage element. In at least some embodiments, the additional processing that is performed in order to confirm that the data chunk associated with the hash value is already stored on the data storage element may include performing a byte-by-byte comparison of the data chunk from the original file contents of the file and the data chunk stored in the matching entry of the data chunk store of the data storage element. It will be appreciated that, where the data chunk stored in the matching entry of the data chunk store of the data storage element is stored in a compressed form, the data chunk is decompressed before the byte-by-byte comparison is performed. If the byte-by-byte comparison of the data chunk from the original file contents of the file and the data chunk stored in the matching entry of the data chunk store of the data storage element results in a determination that the contents of the data chunks are not the same, a determination is made that the data chunk associated with the hash value is not already stored on the data storage element. If the byte-by-byte comparison of the data chunk from the original file contents of the file and the data chunk stored in the matching entry of the data chunk store of the data storage element results in a determination that the contents of the data chunks are the same, a determination is made that the data chunk associated with the hash value is already stored on the data storage element.

The determination as to whether the data chunk associated with the hash value is already stored on the data storage element facilitates the identification of redundant content on the data storage element. The data chunk store maintains data chunks for files stored on the data storage element. Accordingly, searching of the data chunk store of the data storage element functions as a search of the original file contents of files already stored on the data storage element, such that intra-file redundancy and inter-file redundancy both may be identified. In this manner, elimination of redundant content at the data storage element may be improved and, in at least some cases, maximized.

At step 350, the data chunk of the original file contents of the file is stored in the data chunk store of the data storage element. From step 350, method 300 proceeds to step 360.

The data chunk of the original file contents of the file may be stored in the data chunk store by creating an entry in the data chunk store in which the hash value of the data chunk is mapped to the stored form of the data chunk (which may be an uncompressed form or compressed form of the data chunk). This may be performed based on a determination that no matching entry is identified in the data chunk store for the hash value of the data chunk (e.g., no entry of the data chunk store has a hash value that matches the hash value of the selected data chunk of the original file contents of the file). The storage of the data chunk of the original file contents of the file in the data chunk store also may include setting of the local and global reference count fields for the data chunk.

The data chunk of the original file contents of the file may be stored in the data chunk store by storing the data chunk of the original file contents of the file in an existing entry of the data chunk store that has a hash value matching the hash value of the data chunk of the original file contents of the file. In other words, the entry of the data chunk store for the hash value may store multiple data chunks having the same hash value. In embodiments in which a byte-by-byte comparison of the data chunk from the original file contents of the file and the data chunk stored in the matching entry of the data chunk store of the data storage element is performed, this type of storage of the data chunk of the original file contents of the file may be used where the byte-by-byte comparison results in a determination that the hash values are the same but the contents are different. In this case, the storage of multiple data chunks for a common hash value may be performed in such a way that the multiple data chunks are distinguishable during later accesses to the data chunks using the hash value. The storage of the data chunk of the original file contents of the file in the data chunk store also may include updating of the local and global reference count fields for the data chunk.

The data chunk of the original file contents of the file may be stored in the data chunk store by storing the data chunk of the original file contents of the file in a storage location and updating an existing entry in the data chunk store that includes the hash value of the data chunk. In other words, the entry of the data chunk store for the hash value may store multiple references to multiple data chunks having the same hash value (e.g., the data chunk field includes multiple reference identifiers for the multiple data chunks having that hash value). The reference identifiers of the data chunks having that hash value may include respective data chunk storage location identifiers or any other suitable identifiers). In embodiments in which a byte-by-byte comparison of the data chunk from the original file contents of the file and the data chunk stored in the matching entry of the data chunk store of the data storage element is performed, this type of storage of the data chunk of the original file contents of the file may be used where the byte-by-byte comparison results in a determination that the hash values are the same but the contents are different. In this case, the storage of multiple data chunks for a common hash value may be performed in such a way that the multiple data chunks are distinguishable during later accesses to the data chunks using the hash value. The storage of the data chunk of the original file contents of the file in the data chunk store also may include updating of the local and global reference count fields for the data chunk.

The storage of the data chunk of the original file contents of the file in the data chunk store may include a determination as to whether the data chunk is to be stored in an uncompressed form or in a compressed form.

The determination as to whether the data chunk is to be stored in an uncompressed form or in a compressed form may be based on a value of the local reference count for the data chunk. For example, the data chunk may be stored in an uncompressed format when the local reference count of the data chunk is relatively high (e.g., such that it is expected, or at least is more likely, that the data chunk will be referenced during file storage operations or during file access operations such that the file will have to be uncompressed a relatively large number of times as it is accessed) and stored in a compressed format when the local reference count of the data chunk is relatively low (e.g., such that it is not expected, or at least is less likely, that the data chunk will be referenced during file storage operations or during file access operations such that the file will not have to be uncompressed and, thus, may remain in its compressed form until needed). The evaluation of the local reference count of the data chunk for purposes of determining whether or not to compress the data chunk may be based on one or more of a predetermined threshold, a value of the local reference count value of the data chunk relative to local reference count values of other data chunks stored on the data storage element, or the like.

The determination as to whether the data chunk is to be stored in an uncompressed form or in a compressed form may be based on a frequency with which new files enter the data storage device (which may be in any form). For example, the data chunk may be stored in an uncompressed format when the frequency with which new files enter the data storage device (in any form) is relatively high and stored in a compressed format when the frequency with which new files enter the data storage device (in any form) is relatively low.

The data chunk of the original file contents of the file, when stored in a compressed form, may be compressed using any suitable data compression mechanism(s).

At step 355, the data chunk store of the data storage element is updated based on the data chunk. The updating of the data chunk store based on the data chunk may include updating of the local and global reference count fields of the data chunk store for the data chunk. From step 355, method 300 proceeds to step 360.

At step 360, a determination is made as to whether or not the final data chunk of the original file contents of the file has been processed. If the final data chunk of the original file contents of the file has not been processed, the method 300 returns to step 340 (at which point a next hash value of a data chunk of the original file contents of the file is selected. If the final data chunk of the original file contents of the file has been processed, the method 300 proceeds to step 365.

At step 365, the original file contents of the file are processed to remove the data chunks from the original file contents of the file and to add the corresponding hash values of the data chunks to the original file contents of the file, forming thereby an encoded form of the original file contents of the file. It will be appreciated that the encoded form of the original file contents of the file may include one or more hash values of one or more data chunks. It will be appreciated that the hash values may be inserted into the original file contents of the file in any suitable manner (e.g., replacing the data chunks with the corresponding hash values of the data chunks, inserting the hash values of the data chunks into the original file contents of the file using offset information, or the like).

At step 370, the encoded form of the original file contents of the file is compressed to form a compressed, encoded form of the original file contents of the file. The encoded form of the original file contents of the file may be compressed to form the compressed, encoded form of the original file contents of the file using any suitable file compression mechanism(s).

At step 375, the compressed, encoded form of the original file contents of the file is stored on the data storage element. The storage of the compressed, encoded form of the original file contents of the file may include (1) generating or updating metadata for the file, (2) replacing the file contents of the file with the compressed, encoded form of the original file contents of the file and storing the file, and (30 storing the file including the metadata and the file contents.

At step 380, method 300 ends.

It will be appreciated that, although omitted from FIG. 3 for purposes of clarity, a file that is received at a data storage element may be received in a form other than its original form (e.g., in an encoded but not compressed form, in a compressed but not encoded form, in a compressed and encoded form, or the like). In at least some embodiments, a file that is received at a data storage element in a form other than its original form is processed by the data storage element in a manner for returning the file to its original form (e.g., using decompression and/or decoding). A file that is received at a data storage element in a form other than its original form may be processed in a manner for returning the file to its original form in order to enable the data storage element to use the file for purposes of inter-file redundancy reduction. A file that is received at a data storage element in a form other than its original form, after being returned to its original form, may be processed as depicted and described with respect to FIG. 3. It will be appreciated that support for such processing may be provided, because a file can arrive at a data storage element in any form, the data storage element may need to construct a file in various formats, the data storage element may choose to keep or remove any form of the original file contents of a file, a file may exist in different forms on the same storage element or on different storage elements, and so forth.

In at least some embodiments, files 240 may be transferred between data storage elements 201 (e.g., between DSs 110, between a DS 110 and a CD 120, between CDs 120, or the like). As discussed above, files 240 may be transferred between data storage elements 201 for various reasons. It is noted that, given that the data deduplication process that is applied to files may be the same at the data storage elements 201, there may not be a need to differentiate between different types of data storage elements 201 (namely, between DSs 110 and the CDs 120) within the context of transfers of files 240 between data storage elements 201. In at least some embodiments, the storage state on a data storage element 201 is expected to be the same after a file 240 is processed and stored by the data storage element 201, irrespective of whether the file 240 is a new file that is received and processed at the data storage element 201 (e.g., as depicted and described with respect to method 300 of FIG. 3) or whether the file 240 is an existing file that is transferred to the data storage element 201. As described herein, a file 240 includes metadata and file contents, where the file 240 may include a reference to a reference file or the file contents of the file 240 may include a form of the original file contents of the file 240. In either case, the file 240 includes information sufficient for enabling the data storage element 201 to ensure that the information needed in order to reconstruct the original file contents of the file 240 is available at the data storage element 201. Accordingly, reconstruction of the original file contents of a file 240 on a data storage element 201 may require information to be available to the data storage element 201 as follows: (1) if file 240 includes a reference to a reference file, the reference file that is referenced by the file 240 needs to be available on the data storage element 201 and (2) if the file 240 does not include a reference to a reference file, any data chunk referenced in the encoded form of the original file contents of the file 240 needs to be available from the data chunk store 270 of the data storage element 201. In at least some cases, at least a portion of information of a file 240 that is needed by a data storage element 201 in order for the data storage element 201 to reconstruct the original file contents of the file 240 may need to be transferred to the data storage element 201.

In at least some embodiments, the data storage elements 201 may be configured to support a file transfer and reference synchronization mechanism which enables the data storage elements 201 to exchange file information associated with files 240. Various embodiments of file transfer and reference synchronization mechanisms are depicted and described with respect to FIGS. 4-6. An exemplary embodiment for reconstruction of a file 240 at a data storage element 201 is depicted and described with respect to FIG. 7.

In at least some embodiments, a file transfer and reference synchronization protocol is configured to reduce (and possibly minimize) bandwidth overhead by following a principle that a data storage element typically only requests a missing file or data chunk when the missing file or data chunk is needed by the data storage element. An exemplary embodiment is depicted and described with respect to FIG. 4.

FIG. 4 depicts one embodiment of a method for transferring a file from a source data storage element to a target data storage element using a file transfer and reference synchronization protocol. It will be appreciated that the source and target data storage elements may be a pair of DSs 110, a pair of CDs 120, a DS 110 and a CD 120, or the like. It will be appreciated that, although primarily depicted and described as being performed serially, at least a portion of the steps of method 400 may be performed contemporaneously, or in a different order than depicted and described with respect to FIG. 4.

At step 401, method 400 begins.

At step 402, the source data storage element propagates file information of a file toward the target data storage element. At step 404, the target data storage element receives the file information of the file from the source data storage element. The file information of the file includes metadata of the file and file contents of the file. The metadata of the file may include a file name of the file, a file size of the original file contents of the file, a file hash value of the original file contents of the file, and, optionally, a reference to a reference file for the file (i.e., an identical file having a file hash value that is the same as the file hash value of the file being transferred). The file contents of the file may include (1) the original file contents of the file, (2) an encoded form of the original file contents of the file 140, (3) a compressed, encoded form of the original file contents of the file 140, or (4) empty contents (NULL). The file information optionally may include data chunk information for data chunks of the original file contents of the file (e.g., a list of data chunk hash values of data chunks of the original file contents of the file) when the file contents of the file include the encoded form of the original file contents of the file. The various ways in which such information may be used to transfer the file from the source data storage element to the target data storage element is described with respect to other steps of method 400.

At step 406, the target data storage element determines whether the file includes a reference to a reference file. The determination as to whether the file includes a reference to a reference file may include determining whether the metadata of the file includes such a reference or determining whether the file contents of the file includes such a reference. If the file includes a reference to a reference file (an indication that the file contents of the file does not include an encoded form of the original file contents of the file), method 400 proceeds to step 408. If the file does not include a reference to a reference file (an indication that the file contents of the file does include an encoded form of the original file contents of the file), method 400 proceeds to step 420.

At step 408, the target data storage element determines whether the reference file is available on the target data storage element. If the reference file is available on the target data storage element, method 400 proceeds to step 422, at which point method 400 ends. If the reference file is not available on the target data storage element, method 400 proceeds to step 410.

At step 410, the target data storage element propagates a request for the reference file toward the source data storage element. At step 412, the source data storage element receives the request for the reference file from the target data storage element. At step 414, the source data storage element propagates the reference file toward the target data storage element. At step 416, the target data storage element receives the reference file from the source data storage element. At step 418, the target data storage element stores the reference file. It will be appreciated that, although primarily depicted and described with respect to embodiments in which the reference file (including metadata and file contents of the reference file) is transferred from the source data storage element to the target data storage element), in at least some embodiments only the file contents of the reference file are transferred from the source data storage element to the target data storage element. From step 418, method 400 proceeds to step 422, at which point method 400 ends.

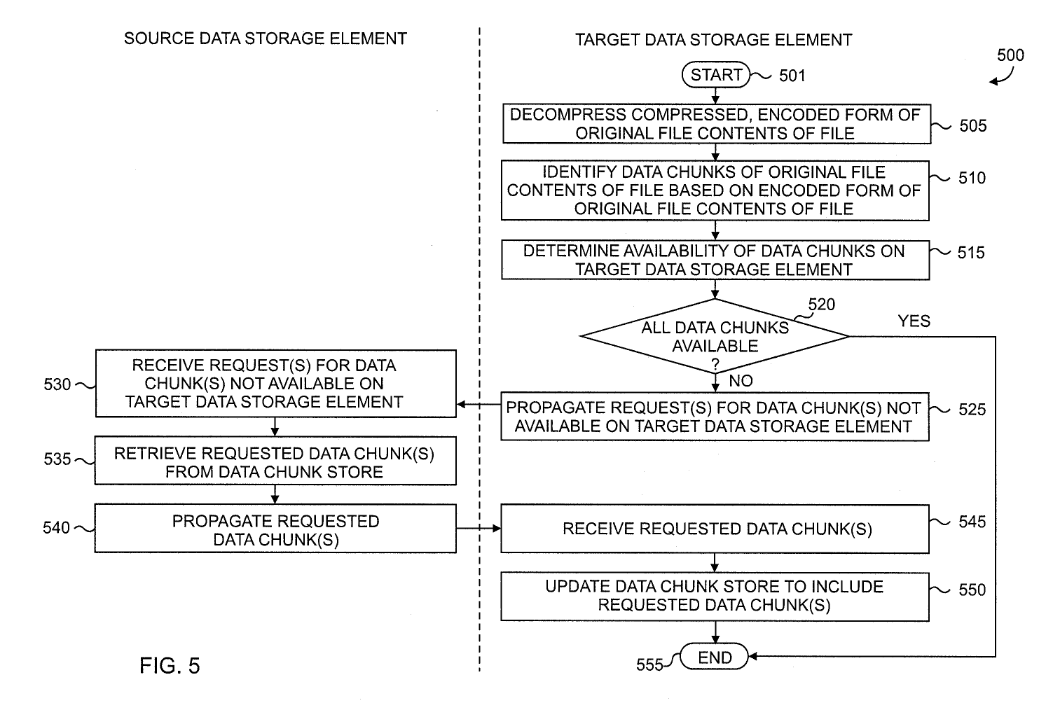

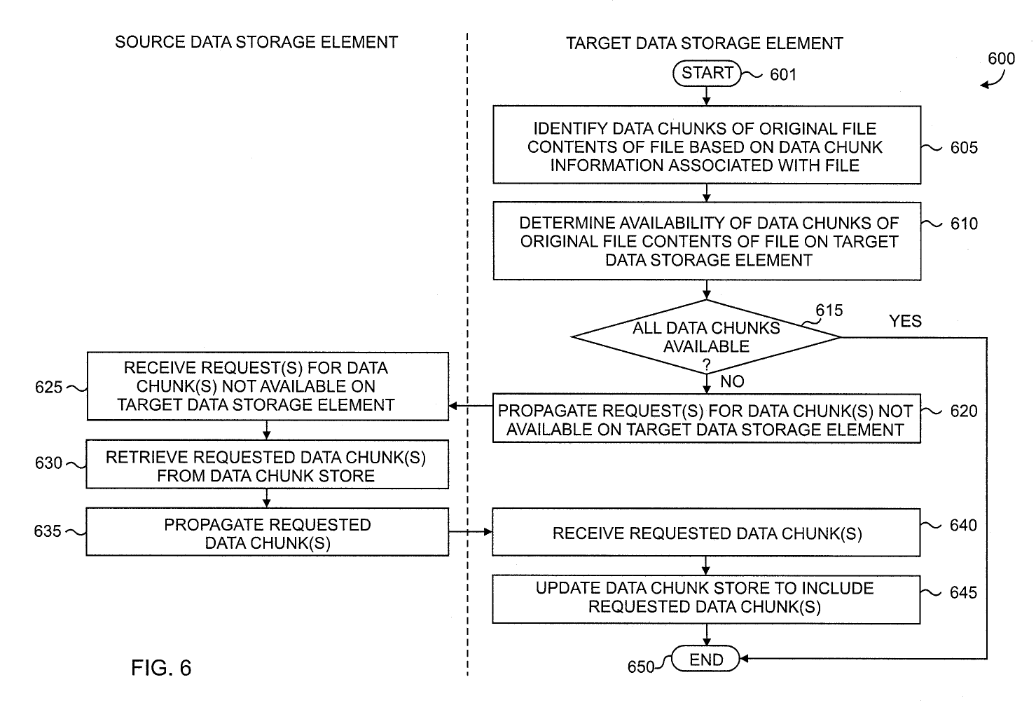

At step 420, the target data storage element ensures that the data chunks for the original file contents of the file are available on the target data storage element. As discussed below, exemplary embodiments via which the target data storage element may ensure that the data chunks for the original file contents of the file are available on the target data storage element are depicted and described with respect to FIG. 5 and FIG. 6. From step 420, method 400 proceeds to step 422, where method 400 ends.

In one embodiment, in which the file information of the file does not include data chunk information for data chunks of an encoded form of the original file contents of the file, the target data storage element decompresses the compressed, encoded form of the original file contents of the file in order to identify the data chunks of which the encoded form of the original file contents of the file is composed, such that the target data storage element may ensure that the data chunks of the original file contents of the file are available on the target data storage element. An exemplary embodiment is depicted and described with respect to FIG. 5. It will be appreciated that this embodiment achieves bandwidth reduction at the expense of increased processing cost of performing decompression of the compressed, encoded form of the original file contents of the file in order to identify the data chunks of which the encoded form of the original file contents of the file is composed.

In one embodiment, in which the file information of the file includes data chunk information for data chunks of an encoded form of the original file contents of the file, the target data storage element identifies the data chunks of which the encoded form of the original file contents of the file is composed based on the data chunk information that is received from the source data storage element as part of the file information of the file, such that the target data storage element may ensure that the data chunks of the original file contents of the file are available on the target data storage element. This obviates the need for the target data storage element to decompress the compressed, encoded form of the original file contents of the file in order to identify the data chunks of which the encoded form of the original file contents of the file is composed. An exemplary embodiment is depicted and described with respect to FIG. 6. It will be appreciated that this embodiment achieves processing cost reduction at the expense of increased bandwidth required for propagation of the data chunk information from the source data storage element to the target data storage element.

At step 422, method 400 ends.

FIG. 5 depicts one embodiment of a method for ensuring availability of data chunks of the original file contents of a file at a target data storage element. It will be appreciated that the source and target data storage elements may be a pair of DSs 110, a pair of CDs 120, a DS 110 and a CD 120, or the like. It will be appreciated that, although primarily depicted and described as being performed serially, at least a portion of the steps of method 500 may be performed contemporaneously, or in a different order than depicted and described with respect to FIG. 5. In at least some embodiments, method 500 of FIG. 5 is suitable for use as step 420 of FIG. 4.

At step 501, method 500 begins. As discussed with respect to FIG. 4, it is assumed that the file contents of the file that is received at the target data storage element from the source data storage element includes the compressed, encoded form of the original file contents of the file, but that the file information that is received at the target data storage element from the source data storage element does not include the data chunk information for the data chunks of the compressed, encoded form of the original file contents of the file. As a result, the target data storage element decompresses the compressed, encoded form of the original file contents of the file in order to identify the data chunks of which the encoded form of the original file contents of file is composed.

At step 505, the target data storage element decompresses the compressed, encoded form of the original file contents of the file to recover the encoded form of the original file contents of the file. The encoded form of the original file contents of the file may include one or more data chunks. Thus, the file also may be said to include one or more data chunks.

At step 510, the target data storage element identifies the data chunks of the original file contents of the file based on the encoded form of the original file contents of the file. The data chunks of the original file contents of the file are indicated by the data chunk hash values of the data chunks that are included within the encoded form of the original file contents of the file, respectively. It will be appreciated that this also may be considered to be identification of the data chunks referenced by the encoded form of the original file contents of the file.

At step 515, the target data storage element determines availability of the data chunks of the original file contents of the file on the target data storage element. The target data storage element may determine availability of the data chunks on the target data storage element by searching the data chunk store of the target data storage element using the data chunk hash values of the data chunks as determined by the target data storage element from the encoded form of the original file contents of the file. For each data chunk having a hash value matching a hash value in an entry of the data chunk store, the data chunk is available on the target data storage element. For each data chunk having a hash value that does not match any entries of the data chunk store, the data chunk is not available on the target data storage element.

At step 520, a determination is made as to whether all of the data chunks of the original file contents of the file are available on the target data storage element. If all of the data chunks of the original file contents of the file are not available on the target data storage element, method 500 proceeds to step 525. If all of the data chunks of the original file contents of the file are available on the target data storage element, method 500 proceeds to step 555, at which point method 500 ends.

At step 525, the target data storage element propagates, toward the source data storage element, a request(s) for any data chunk(s) not available on the target data storage element. At step 530, the source data storage element receives, from the target data storage element, the request(s) for any data chunk(s) not available on the target data storage element. The request(s) may include one or more data chunk hash values of the data chunk(s) not available on the target data storage element.

At step 535, the source data storage element retrieves the requested data chunk(s) identified in the request for data chunk(s) not available on the target data storage element. The source data storage element retrieves the data chunk(s) from its data chunk store based on the data chunk hash value(s) of the data chunk(s).

At step 540, the source data storage element propagates the requested data chunk(s) toward the target data storage element. At step 545, the target data storage element receives the requested data chunk(s) from the source data storage element.

At step 550, the target data storage element updates its data chunk store to include the data chunk(s) received from the source data storage element. The target data storage element may add one or more entries to the data chunk store for the one of more data chunk(s) received from the source data storage element, respectively.

At step 555, method 500 ends.

It will be appreciated that, although primarily depicted and described with respect to embodiments in which method 500 of FIG. 5 is used as step 420 of FIG. 4 (i.e., embodiments in which transfer of the missing data chunk(s) of the compressed form of the original file contents of the file from the source data storage element to the target data storage element is performed at or near the time at which the file is transferred from the source data storage element to the target data storage element), in at least some embodiments the method 500 of FIG. 5 may be invoked outside of the context of method 400 of FIG. 4 (e.g., when the file is accessed by a user from the target data storage element or in response to any other suitable type of trigger condition). In this manner, the overhead associated with updating of the data chunk store of the target data storage element may be delayed until a later time.

FIG. 6 depicts one embodiment of a method for ensuring availability of data chunks of the original file contents of a file at a target data storage element. It will be appreciated that the source and target data storage elements may be a pair of DSs 110, a pair of CDs 120, a DS 110 and a CD 120, or the like. It will be appreciated that, although primarily depicted and described as being performed serially, at least a portion of the steps of method 600 may be performed contemporaneously, or in a different order than depicted and described with respect to FIG. 6. In at least some embodiments, method 600 of FIG. 6 is suitable for use as step 420 of FIG. 4.

At step 601, method 600 begins. As discussed with respect to FIG. 4, it is assumed that the file contents of the file that are received at the target data storage element from the source data storage element include the compressed, encoded form of the original file contents of the file and, further, that the file information that is received at the target data storage element from the source data storage element includes the data chunk information for the data chunks of the original file contents of the file. As a result, the target data storage element does not need to decompress the compressed, encoded form of the original file contents of the file in order to identify the data chunks of which the encoded form of the original file contents of file is composed.

At step 605, the target data storage element identifies the data chunks of the original file contents of the file. The target data storage element identifies the data chunks of the original file contents of the file based on the data chunk information received in conjunction with the file. The data chunks of the original file contents of the file are indicated by the data chunk hash values of the data chunks that are included within the encoded form of the original file contents of the file, respectively. It will be appreciated that this also may be considered to be identification of the data chunks referenced by the encoded form of the original file contents of the file and, thus, of the data chunks referenced by compressed, encoded form of the original file contents of the file.

At steps 610-645, the target data storage element determines which, if any, of the data chunks of the original file contents of the file are not available in the data chunk store of the target data storage element and, if one or more of the data chunks of the original file contents of the file are not available in the data chunk store of the target data storage element, requests that the source data storage element provide any data chunks not available in the data chunk store of the target data storage element so that the target data storage element may update its data chunk store such that its data chunk store includes all of the data chunks of the original file contents of the file. In at least one embodiment, steps 610-645 of method 600 of FIG. 6 may be implemented as depicted and described with respect to steps 515-550 of method 500 of FIG. 5. From steps 615 (based on a determination that all data chunks of the original file contents of the file are available on the target data storage element) and 645, method 600 proceeds to step 650, where method 600 ends.

At step 650, method 600 ends.

It will be appreciated that, although primarily depicted and described with respect to embodiments in which method 600 of FIG. 6 is used as step 420 of FIG. 4 (i.e., embodiments in which transfer of the missing data chunk(s) of the compressed file from the source data storage element to the target data storage element is performed at or near the time at which the compressed file is transferred from the source data storage element to the target data storage element), in at least some embodiments the method 600 of FIG. 6 may be invoked independent of method 400 of FIG. 4 (e.g., when the file is accessed by a user from the target data storage element or in response to any other suitable type of trigger condition). In this manner, the overhead associated with updating of the data chunk store of the target data storage element may be delayed until a later time.

FIG. 7 depicts one embodiment of a method for reconstructing a file using data chunks at a data storage element. It will be appreciated that, although primarily depicted and described as being performed serially, at least a portion of the steps of method 700 may be performed contemporaneously, or in a different order than depicted and described with respect to FIG. 7.

At step 701, method 700 begins.

At step 705, the metadata of the file is retrieved. The metadata of the file may include the file name of the file, the file size of the file, the hash value computed for the file, and, optionally, a reference to a reference file having a file hash value that matches a file hash value of the file.

At step 710, a determination is made as to whether the metadata of the file includes a reference to a reference file. If the metadata of the file includes a reference to a reference file (an indication that a compressed, encoded form of the original file contents of the file is not stored on the data storage element), method 700 proceeds to step 715. If the metadata of the file does not include a reference to a reference file (an indication that a compressed, encoded form of the original file contents of the file is stored on the data storage element), method 700 proceeds to step 725.

At step 715, the file contents of the reference file, indicated by the reference included within the metadata of the file, are retrieved. At step 720, the original file contents of the file are reconstructed based on the file contents of the reference file. From step 720, method 700 proceeds to step 755.

At step 725, the compressed, encoded form of the original file contents of the file is decompressed to recover the encoded form of the original file contents of the file. The compressed, encoded form of the original file contents of the file may be decompressed based on the type of compression process used to compress the encoded form of the original file contents of the file. The encoded form of the original file contents of the file may include one or more data chunk hash values of one or more data chunks.

At step 730, a (next) data chunk hash value is selected from the encoded form of the original file contents of the file. At step 735, a compressed form of the data chunk is retrieved from the data chunk store based on the data chunk hash value. At step 740, the compressed data chunk is decompressed to recover the data chunk associated with the hash value. At step 745, the data chunk hash value is removed from the encoded form of the original file contents of the file and the data chunk is inserted into the encoded form of the original file contents of the file. At step 750, a determination is made as to whether the final data chunk hash value has been removed from the encoded form of the original file contents of the file. If the final data chunk hash value has not been removed from the encoded form of the original file contents of the file, method 700 returns to step 730, at which point a next data chunk hash value is selected from the encoded form of the original file contents of the file. If the final data chunk hash value has been removed from the encoded form of the original file contents of the file, method 700 proceeds to step 755. In this manner, an iterative process may be used to reconstruct the original file contents of the file based on data chunks maintained in the data chunk store.

At step 755, one or more functions are performed for the reconstructed original file contents of the file. For example, the reconstructed original file contents of the file may be stored on the data storage element (e.g., using the existing file by replacing the file contents of the file with the reconstructed original file contents of the file, by storing the original file contents of the file as a new file using a different file name, or the like). For example, the reconstructed original file contents of the file may be propagated to one or more output interfaces, such as a presentation interface (e.g., display interface, speaker, printer, or the like, which may depend on the type of content included within the file), a transmission interface (e.g., for transmission of the reconstructed file toward one or more other elements or devices), or the like, as well as various combinations thereof.

At step 760, method 700 ends.

It will be appreciated that, although omitted from FIG. 7 for purposes of clarity, when the original file contents of the file are reconstructed based on data chunks of the data chunk store of the data storage element, the data storage element may ensure that the data chunks of the file are available in the data chunk store of the data storage element in conjunction with reconstruction of the original file contents of the file.

In at least some embodiments, this step may be performed as an optionally check, e.g., where method 500 or method 600 was previously executed such that it is expected that all of the data chunks of the file are available at the data storage element, but an additional sanity check is performed due to changes that may have occurred in the data chunk store of the data storage element between the time at which the data storage element first ensured that the data chunks of the file were available and the time at which method 700 is invoked (e.g., the time between transfer of the file to the data storage element and the event which is triggering reconstruction of the file, such as when the file is accessed by a user).

In at least some embodiments, this step may be performed as the first instance at which the data storage element first ensures that the data chunks of the file are available in the data chunk store of the data storage element (e.g., rather than executing method 500 or method 600 as step 420 of FIG. 4, step 420 is not executed as part of method 400, but, rather, is executed as the first portion of method 700). In other words, the steps performed by the data storage element to ensure availability of the data chunks of the file are delayed from being performed at or near the time at which the file is transferred to the data storage element to being performed at or near the time at which the file is reconstructed at the data storage element (e.g., at or near the time of the event which is triggering reconstruction of the file, such as when the file is accessed by a user).

It will be appreciated that, although method 700 of FIG. 7 is primarily depicted and described with respect to embodiments in which the reference for the reference file is expected to be located within the metadata of the file, in at least some embodiments, as discussed herein, the reference for the reference file alternatively or also may be expected to be located within the file contents of the file. In at least some such embodiments, step 705 may be omitted from method 700 and one or more other steps of method 700 may be modified accordingly (e.g., step 710 may be modified to a determination as to whether the file contents of the file includes a reference to a reference file or a determination as to whether the file includes a reference to a reference file).

In at least some embodiments, one or more file deletion capabilities or garbage collection capabilities may be supported.

As described herein with respect to FIG. 2, the hash value of a file 240 located on a data storage element 201 has a local reference count field 263 and a global reference count field 264 associated therewith. The local reference count field 263 for the hash value of a file 240 is set to an initial value (e.g., 1 or any other suitable value) when the hash value of the file 240 is first computed, and the local reference count field 263 for the hash value of the file 240 is incremented when another file maintained on the data storage element 201 uses the hash value associated with that entry of the file hash store 260. The global reference count field 264 for the hash value of a file 240 is the maximum value of the local reference count fields 263 of the hash value of the file 240 across the data storage elements 201 of the communication system 100. The global reference count fields 264 of the file hash stores 260 of the data storage elements 201 may be updated periodically or in response to any suitable trigger condition. The local reference count fields 263 and the global reference count fields 264 of the file hash stores 260 of the data storage elements 201 may be used to support file deletion capabilities or garbage collection capabilities.

As described herein with respect to FIG. 2, the hash value of a data chunk located on a data storage element 201 has a local reference count field 273 and a global reference count field 274 associated therewith. The local reference count field 273 for the hash value of a data chunk is set to an initial value (e.g., 1 or any other suitable value) when the entry for the data chunk is added to the data chunk store 270 (indicative that there is one file 240 on the data storage element 201 that is using the data chunk), and the local reference count field 273 for the data chunk is incremented when another file (in its compressed form) maintained on the data storage element 201 uses the data chunk associated with that entry of the data chunk store 270. The global reference count field 274 for a data chunk is the maximum value of the local reference count fields 273 of the data chunk across all of the data storage elements 210 of the communication system 100. The global reference count fields 274 of the data chunk stores 270 of the data storage elements 201 may be updated periodically or in response to any suitable trigger condition. The local reference count fields 273 and the global reference count fields 274 of the data chunk stores 270 of the data storage elements 201 may be used to support file deletion capabilities or garbage collection capabilities.

As describe above, updating of the global reference count information (e.g., global reference count fields 264 of the file hash stores 260 and the global reference count fields 274 of the data chunk stores 270) of the data storage elements 201 may be performed periodically or in response to any suitable trigger conditions. In at least some embodiments, the data storage elements 201 of the communication system 100 periodically exchange their global reference count information, such that the data storage elements 201 of the communication system 100 may update their global reference count information (e.g., by using the maximum global reference count values from the data storage elements 201 of communication system 100).

It will be appreciated that the global reference count values for files and data chunks do not need to be accurate, since the global reference count values for files and data chunks are used for local removal, by data storage elements 201, of respective files or data chunks that are (1) not referenced locally by the respective data storage elements 201 and (2) potentially not referenced globally by any data storage elements 201 of communication system 100. In at least some embodiments, a protocol used to determine the global reference count value for a given file or a given data chunk may run periodically in time slots of length T. The value of T may be set based on a tradeoff between accuracy and message load incurred by the protocol used to exchange global reference count information between data storage elements 201. For example, a smaller value of T may result in higher accuracy of the global reference count values but at the expense of higher overhead load introduced to the system by message exchanges between the data storage elements 201. It will be appreciated that the start time of each time slot T at the data storage elements 201 does not need to be synchronized as, again, the global reference count values for files and data chunks do not need to be accurate. Accordingly, the data storage elements 201 may set the start times of the time slots based on clocks available at the respective data storage elements 201. It will be appreciated that the same or different time slots may be used for the global reference count values of files and the global reference count values of data chunks. In at least some embodiments, at the beginning of a time slot for a global reference count field on a data storage element 201, the data storage element 201 initializes the global reference count value of the global reference count field to the local reference count value of the corresponding local reference count field of the corresponding file or data chunk, thereby removing the accumulated history of previous timeslots in the global reference count field. The data storage elements 201 may periodically exchange global reference count information, for use in updating global reference count fields of the data storage elements 201, using one or more protocols. The set of global reference count information of a data storage element 201 may include the global reference count values of the global reference count fields 264 of the file hash store 260 for the files 240 maintained on the data storage element 201 and the global reference count values of the global reference count fields 274 of the data chunk store 270 for the data chunks maintained on the data storage element 201.

In at least some embodiments, data storage elements 201 may use a multicast protocol for updating global reference count fields. The use of a multicast protocol by a data storage element 201 enables the data storage element 201 to multicast its set of global reference count information to each of the other data storage elements of communication system 100. A data storage element 201, at the beginning of a timeslot tᵢ, may use a multicast protocol to multicast, to other data storage elements 201, its set of global reference count information and an indication of its associated timeslot tᵢ. A data storage element 201, upon receiving a multicast including a set of global reference count information and an indication of the associated timeslot tᵢ for the set of global reference count information, updates its own global reference count information based on the received global reference count information. In at least some embodiments, a data storage element 201 updates its own global reference count information by: (1) for each of the existing global reference count fields 264 of the file hash store 260, updating the value of the global reference count field 264 to be the maximum global reference count value (e.g., the existing value or the received value) for the associated timeslot tᵢ and (2) for each of the existing global reference count fields 274 of the data chunk store 270, updating the value of the global reference count field 274 to be the maximum global reference count value (e.g., the existing value or the received value) for the associated timeslot tᵢ.

In at least some embodiments, data storage elements 201 may use a gossip-type protocol for updating global reference count fields. The use of a gossip-type protocol by a data storage element 201 is similar to use of a multicast protocol by a data storage element, however, the data storage element 201 sends its set of global reference count information to a random subset of the other data storage elements 201 of communication system 100. It will be appreciated that, since the maximum value calculation for updating of global reference count values is cumulative or aggregative, a gossip-style protocol may be used to update global reference count information across the various data storage elements using less messages than would be used with a multicast protocol.

It will be appreciated that, since the local clocks of the data storage elements 201 may not be synchronized, it is possible to receive global reference count information associated with different timeslots. In at least some embodiments, data storage elements 201 may be configured to maintain multiple global reference count values for the multiple timeslots. For example, an entry of the file hash store 260 of a data storage element 201 may include multiple global reference count fields 264, storing multiple global reference count values for that file 240 of the entry, for the multiple timeslots. Similarly, for example, an entry of the data chunk store 270 of a data storage element 201 may include multiple global reference count fields 274, storing multiple global reference count values for that data chunk of the entry, for the multiple timeslots. In at least some embodiments, the number of global reference count values/fields that may be maintained by a data storage element 201 may be limited since only a few of the most recent global reference count values may be used in file deletion and garbage collection at the data storage element 201. In at least some embodiments, in which multiple global reference count values are associated with a file 240 (e.g., in an entry of the file hash store 260) or a data chunk (e.g., in an entry of the data chunk store 270), the multiple global reference count values may be used as a basis for determining whether or not to remove the file 240 or data chunk, respectively. In at least some embodiments, for example, when multiple global reference count values are associated with a file 240 (or a data chunk, a maximum global reference count value from among the multiple global reference count values may be used as a basis for determining whether or not to remove the file 240 or data chunk, respectively. For example, even if the global reference count value of the file 240 or data chunk reaches zero in some of the most recent timeslots, the file 240 or data chunk may still be referenced in the future and, thus, the actual removal (or marking for removal) of the file 240 or data chunk may be delayed until storage space is needed at the data storage element 201.

In at least some embodiments, a local file deletion capability is provided. The local file deletion capability removes a file 240 from a single data storage element 201 of the communication system 100.

In at least some embodiments, when a file 240 is deleted locally from a data storage element 201: (1) the file hash store 260 of the data storage element 201 is updated by decreasing the local reference count value of the local reference count field 263 of the entry of the file hash store that is associated with the file 240 and (2) the data chunk store 270 of the data storage element 201 is updated by decreasing the local reference count values of the local reference count fields 273 of entries of the data chunk store 270 associated with the data chunks included within the original file contents of the file 240. It will be appreciated that the manner in which the local reference count field 273 for a given data chunk is updated may depend on the type of value stored within the local reference count field 273 for the given data chunk as follows: (1) when the local reference count field 273 for the given data chunk includes a value indicative of the total number of files 240 stored locally on the data storage element 201 that refer to the data chunk, the value of the local reference count field 273 for the data chunk is decreased by one or (2) when the local reference count field 273 for the given data chunk includes a value indicative of the number of times that the data chunk is referenced by files 240 stored locally on the data storage element 201, the value of the local reference count field 273 for the data chunk may be decreased by one or more depending on the number of times that the data chunk was referenced by the deleted file 240.

In at least some embodiments, when the local reference count value of the local reference count field 263 of an entry of the file hash store 260 associated with a file 240 reaches a value indicative that the file 240 is no longer present on the data storage element 201 (e.g., 0, or any other suitable value, which may depend on the initial value that was used when the file 240 was initially stored on the data storage element 201), the data storage element 201 deletes that entry of the file hash store 260 that is associated with the file 240.

In at least some embodiments, management of an entry of the data chunk store 270 that is associated with a data chunk may be made based on reference count information associated with the data chunk (e.g., based on one or both of the local reference count value of the local reference count field 273 of that entry of the data chunk store 270 and the global reference count value of the global reference count field 274 of that entry of the data chunk store 270), policy or preference information, or the like, as well as various combinations thereof.

In at least some embodiments, when the local reference count value of the local reference count field 273 of an entry of the data chunk store 270 reaches a value indicative that the data chunk is no longer referenced by a file 240 stored locally on the data storage element 201 (e.g., 0, or any other suitable value, which may depend on the initial value that was used when the data chunk was initially stored on the data storage element 201), the data storage element 201 deletes that entry of the data chunk store 270 that is associated with the data chunk (e.g., to save storage space on the data storage element 201).

In at least some embodiments, when the local reference count value of the local reference count field 273 of an entry of the data chunk store 270 reaches a value indicative that the data chunk is no longer referenced by a file 240 stored locally on the data storage element 201 (e.g., 0, or any other suitable value, which may depend on the initial value that was used when the data chunk was initially stored on the data storage element 201), the data storage element 201 determines whether or not to delete that entry of the data chunk store 270 that is associated with the data chunk based on the value of the global reference count field 274 of that entry of the data chunk store 270. In one embodiment, when the global reference count value of the global reference count field 274 of the entry of the data chunk store 270 has not yet reached a value indicative that the data chunk is no longer referenced by any files 240 stored on any of the data storage elements 201 of communication system 100, that entry of the data chunk store 270 that is associated with the data chunk is not deleted. In one embodiment, when the global reference count value of the global reference count field 274 of the entry of the data chunk store 270 reaches a value indicative that the data chunk is no longer referenced by any files 240 stored on any of the data storage elements 201 of communication system 100, that entry of the data chunk store 270 that is associated with the data chunk may be deleted (e.g., to save data storage space) or may not be deleted (e.g., since there is still a chance that a new file stored in the communication system 100 later may use that data chunk even though that data chunk is not currently referenced by any of the existing files stored in the communication system 100).

In at least some such embodiments, the entry of the data chunk store 270 that is associated with a data chunk may be deleted, irrespective of one or both of the local and global reference count values of the local and global reference count fields 273 and 274 of the entry of the data chunk store 270, based on a determination that additional storage space is needed for the data chunk store 270 on the data storage element 201.

In at least some embodiments, a global file deletion capability is provided. The global file deletion capability enables a single data storage element 201 to initiate removal of a file 240 from all of the data storage elements 201 of communication system 100. The data storage element 201 initiating removal of a file 240 from all of the data storage elements 201 sends a global file deletion command, identifying the file 240, to each of the other data storage elements 201 of communication system 100. The other data storage elements 201 of communication system 100, upon receiving the global file deletion command, perform local file deletion functions for the identified file 240 to be deleted (e.g., using the local file deletion capability discussed above to update the file hash stores 260 and the data chunk stores 270 of the data storage elements 201). It will be appreciated that any suitable type of protocol may be used to propagate the global file deletion command between data storage elements 201.

In at least some embodiments, the data storage elements 201 may periodically run a garbage collection process in order to clean up storage space occupied by orphan file hashes and orphan data chunks. In at least some embodiments, an orphan file hash is an entry of the file hash table that does not have a corresponding file stored on any of the data storage elements 201 of communication system 100 (e.g., a file hash for which the global reference count field 264 is zero or any other value suitable for indicating that the file associated with the file hash is not stored on any of the data storage elements 201 of communication system 100). In at least some embodiments, an orphan data chunk is a data chunk that is not referenced by any of the files 240 in communication system 100 (e.g., data chunks for which the global reference count field 274 is zero or any other value suitable for indicating that the data chunk is not referenced by any of the files 240 in communication system 100).

In at least some embodiments, a data storage element 201 may evaluate some or all of the data chunks of its data chunk store 270 in order to determine whether the storage format of the data chunks of its data chunk store 270 are to be modified (e.g., compressing one or more currently uncompressed data chunks or uncompressing one or more currently compressed data chunks). In at least some embodiments, a data storage element 201 may evaluate a data chunk based on one or more of a value of the local reference count for the data chunk, a frequency with which new files enter the data storage device in their original form, or the like, as well as various combinations thereof. For example, a data chunk may be compressed based on a determination that the local reference count of the data chunk is relatively high. For example, a data chunk may be uncompressed based on a determination that the local reference count of the data chunk is relatively low. For example, a data chunk may be compressed based on a determination that a frequency with which new files have entered or are entering the data storage device in their original form is relatively low. For example, a data chunk may be uncompressed based on a determination that a frequency with which new files have entered or are entering the data storage device in their original form is relatively high.

As described herein, the set of files for which data deduplication may be performed may include a subset of the full set of files for which data deduplication could be applied (e.g., a subset of the full set of files owned or managed by a user or set of users). In at least some embodiments, the subset of files for which data deduplication is performed may be selected based on file types of the files for which data deduplication could be applied. For example, the subset of files may only include one or more types of files which exhibit or are expected to exhibit sufficient redundancy, within or across files, to warrant application of data deduplication. It is noted that the subset of files which exhibit or are expected to exhibit sufficient redundancy may be determined based on based on one or more factors, such as storage costs of storing the files (e.g., per-block storage costs of a cloud-based storage service), bandwidth costs associated with transfers of the files, or the like, as well as various combinations thereof. Similarly, data deduplication does not need to be performed for any files which do not exhibit or are not expected to exhibit sufficient redundancy, within or across files, to warrant application of data deduplication.

In at least some embodiments, the data deduplication capability may be applied in order to achieve data deduplication for a personal data storage service within the network (e.g., a cloud-based personal data storage service). In many cases, the types of files typically stored in a cloud-based personal data storage service often lack enough redundancy to warrant the processing costs of performing data deduplication. In many cases, for example, a cloud-based personal data storage service typically is used to store various types of compressed files (e.g., compressed audio files, compressed image files, compressed video files, compressed PDF files, or the like) and encrypted files. However, depending on the type of compression used for certain types of compressed files, it still may be possible to find a percentage of inter-file redundancy sufficiently large to warrant the processing costs of performing data deduplication (e.g., 10%-15% for compressed image and PDF files). Thus, various embodiments of the data deduplication capability may be applied in order to achieve data deduplication for a personal data storage service within the network.

It will be appreciated that, although primarily depicted and described with respect to embodiments in which it is assumed that hash collisions on files will not occur, in at least some embodiments or implementations it may be possible that hash collisions may occur for files 240 on different data storage elements 201 or for files 240 or data chunks of files 240 on the same data storage element 201.

In at least some embodiments, one or more capabilities may be provided for preventing or handling hash collisions for files 240 on different data storage elements 201. In at least some embodiments, if a file 240 includes a reference to a reference file, the reference file that is referenced by the file 240 needs to be available on the data storage element 201. In at least some embodiments, the determination as to whether there is a hash collision for a file 240 on a data storage element 201 may be performed using one of the following options: (1) if an assumption is made that files 240 having identical file names and residing on different data storage elements 201 have identical file contents, a determination may be made as to whether the file name of the reference file exists on the data storage element 201 or, (2) if an assumption is not made that files 240 having identical file names and residing on different data storage elements 201 have identical file contents, a determination may be made as to whether the file name of the reference file exists on the data storage element 201 and, further, a determination may be made as to whether size of the reference file matches the file size of the file 240. In each of the foregoing options, a determination is made that the reference file does not exist for the file 240 on the data storage element 201 based on a determination that the reference file does not exist on the data storage element 201 (e.g., for option (1) or option (2) discussed above) or based on a determination that the reference file size does not match file size for file 240 (e.g., for option (2) discussed above). Furthermore, in at least some embodiments in which a source data storage element 201 is to transfer a file 240 that references a reference file to a target data storage element 201, since it may be difficult for the source data storage element 201 to be certain that a reference file exists on a target data storage element 201, the source data storage element 201 transfers one of the available forms of the reference file (e.g., the compressed and encoded form, the encoded but uncompressed form, or the like) to the target data storage element 201. In at least some embodiments, when a new file 240 (without a reference file) is received at a data storage element 201, the file hash value of the file 240 is inserted into the file hash store 260 at the data storage element 201 and any potential hash collision that is local to the data storage element 201 may be prevented or handled using any of the embodiments for preventing or handling hash collisions for files 240 on the same data storage element 201 (since any file 240 with a file hash value is local on that data storage element 201).

In at least some embodiments, one or more capabilities may be provided for preventing or handling hash collisions for files 240 or data chunks of files 240 on a given data storage element 201. In at least some embodiments, hash value collisions for files 240 or data chunks of files 240 on a given data storage element 201 may be handled by using an additional field (e.g., an additional field in the file hash store 260 for hash collisions on file hash values of files 240 or an additional field in the data chunk store 270 for hash collisions on the data chunk hash values of data chunks of files 240). In at least some embodiments, hash value collisions for files 240 or data chunks of files 240 on a given data storage element 201 may be handled by preventing storage of an entry having an identical hash value as follows: (1) for a file 240 having a file hash value, preventing storage of the file 240 having the file hash value in the file hash store 260 based on a determination that the file hash value of the file is the same as a file hash value of an existing file 240 of the file hash store 260 and a determination (e.g., using a byte-by-byte comparison) that the content of the file 240 is different than the content of the existing file 240 of the file hash store 260, or (2) for a data chunk having a data chunk value, preventing storage of the data chunk having the data chunk value in the data chunk store 270 based on a determination that the data chunk value of the data chunk is the same as a data chunk value of an existing data chunk of the data chunk store 270 and a determination (e.g., using a byte-by-byte comparison) that the content of the data chunk is different than the content of the existing data chunk of the data chunk store 270. In at least some embodiments, since the hash function that is used to compute hash values may be selected in a manner tending to reduce the probability of hash value collisions and, if a hash value collision does occur at a data storage element 201 the hash value collision may be handled as follows: (1) in the case of a file hash value collision, encoding the file 240 as if the file 240 does not have an associated reference file (and, thus, the file 240 does not refer to the reference file) or (2) in the case of a data chunk hash value collision, preventing encoding of the data chunk. It will be appreciated that there may be tradeoffs between embodiments in an additional field(s) is used and embodiments in which an additional field(s) is not used (e.g., embodiments in which an additional field(s) is not used result in simplification of encoding format and simplification of the synchronization protocol with the potential for increases in encoded file size and the potential for increases in bandwidth that is used between the data storage elements 201).

In at least some embodiments, one or more capabilities may be provided for preventing or handling hash collisions for data chunks of files 240 on different data storage elements 201. It is noted that where two data chunks have the same hash value but are located on different data storage elements 201: (1) a determination as to whether the content of the two data chunks is identical requires a comparison of the content of the two data chunks (e.g., a byte-by-byte comparison) and (2) a comparison of two data chunks on two different data storage elements 201 generally cannot be performed without transferring one of the data chunks from one of the data storage elements 201 to the other one of the data storage elements 201. In at least some embodiments (the embodiments primarily depicted and described herein), an assumption may be made that identical data chunk values of two data chunks indicate that the data chunk content of the two data chunks is identical, and a file 240 is transferred from a source data storage element 201 to a target data storage element 201 in its compressed and encoded form and one or more synchronization protocols may be used by the target data storage element 201 to obtain from the source data storage element 201 any data chunks of the file 240 that are not available on the target data storage element 201. In at least some embodiments, when an additional field(s) is used to deal with multiple data chunks having the same hash value, the additional field(s) is provided at each of the data storage elements such that a given data chunk may be uniquely identified by a combination of the data chunk hash value of the given data chunk and the additional field(s) associated with the given data chunk and, thus, a target data storage element 201 that receives a file 240 including the given data chunk can compare the information from the fields of an existing data chunk in its data chunk store 260 and the corresponding information of the given data chunk of the received file 240 to determine if the information is the same (e.g., if the information matches, the target data storage element 201 does not need to request that data chunk from the source data storage element 201, otherwise the target data storage element 201 will need to request that data chunk from the source data storage element 201).

In at least some embodiments, one or more other types of synchronization protocols may be used in order to transfer a file 240 from a source data storage element 201 to a target data storage element 201. For example, other types of synchronization protocols may include transferring the file 240 in its original (unencoded and uncompressed) form, transferring a compressed but unencoded form of the file 240, transferring an encoded form of the file 240 (which may be uncompressed or compressed) while also transferring the data chunk entries of the data chunk store 270 on the source data storage element 201 that are referenced by the file 240, or the like, as well as various combinations thereof. It is noted that the last option (in which both the file 240 and the data chunk entries referenced by the file 240 are sent) may result in higher bandwidth utilization than the first two options (in which the data chunk entries referenced by the file 240 are not sent), which may depend on how much intra-file redundancy is captured in the encoded form of the file 240. It will be appreciated that, in each of the above-described options for the synchronization protocol, data chunk hash collisions may occur on the target data storage element 201, which may be handled based on embodiment as described above for handling of data chunk hash collisions on the same data storage element 201. In at least some embodiments, when a new file 240 is received at the target data storage element 201, the target data storage element processes data chunks included in the new file 240 which includes, based on a determination that a data chunk does not exist in the data chunk store 270 of the target data storage element 201, inserting an entry for the data chunk into the data chunk store 270 of the target data storage element 201 such that the data chunk is indexed at least by the hash value of the data chunk.

In at least some embodiments, in which a hash value of a data chunk is used to index the data chunk in the data chunk store 270 of the target data storage element 201 (but an additional field is not used), a determination is made for a data chunk of a new file 240 as to whether the data chunk store 270 of the target data storage element 201 includes an entry having a hash value that matches the hash value of the data chunk of the new file, a comparison of the data chunks (e.g., byte-by-byte comparison) is performed based on a determination that the data chunk hash value of the new data chunk of the new file 240 matches the data chunk hash value of the existing data chunk of the data chunk store, and processing may be performed based on the result of the comparison as follows: (a) based on a determination that the data chunks have identical content, the data chunk in the new file 240 (which may be in any form when the new file 240 is received, depending on the type of synchronization protocol being used) may be represented in the new file 240 using the hash value of the data chunk (i.e., in its most efficient form without hash collision) or (b) based on a determination that the data chunks do not have identical content, the data chunk in the new file 240 (which may be in any form when the new file 240 is received, depending on the type of synchronization protocol being used) is represented in the new file 240 in the form of the original data chunk (which may include replacing the hash value of the data chunk in the new file 240 with the original data) and, further, the data chunk is not stored in the data chunk store 270 of the target data storage element 201 (i.e., the entry of the data chunk store 270 having the matching data chunk hash value is not changed) since a hash collision has occurred.

In at least some embodiments, in which a hash value of a data chunk and an additional field may be used to index the data chunk in the data chunk store 270 of the target data storage element 201, the data storage elements 201 of the system use identical mechanisms for computing the additional field for data chunks in their respective data chunk stores 270, but it is not required that the additional field exist in each data chunk store 270 of each data storage element 201 of the system. In other words, in any given data storage element 201, a data chunk may be represented using the data chunk hash value of the data chunk or a combination of the data chunk hash value of the data chunk and the additional field for the data chunk. Thus, for a given data chunk, a data storage element 201 may perform a hash value comparison and, optionally, also an additional field comparison. In at least some embodiments, when a new file 240 is received at a target data storage element 201, the data chunk hash value comparison may include: (1) when the data chunk in the new file 240 is in the form of its original content, applying a hash function to the original content of the data chunk in order to generate the data chunk hash value for the data chunk and then comparing the generated data chunk hash value of the data chunk with data chunk hash values of the data chunk store 270 of the target data storage element 201, or (2) when the data chunk in the new file 240 is represented within the new file 240 using its hash value, retrieving the hash value from the new file 240 and comparing the retrieved data chunk hash value of the data chunk with data chunk hash values of the data chunk store 270 of the target data storage element 201. In at least some embodiments, when a new file 240 is received at a target data storage element 201, the data chunk hash value comparison is performed and, additionally, a comparison based on the additional field is performed. The comparison based on the additional field may be include: (1) when the data chunk in the new file 240 is in the form of its original content, generating the value of the additional field based on the original content of the data chunk for use in the additional field comparison, (2) when the data chunk in the new file 240 is represented within the new file 240 using its hash value and the value of the additional field, retrieving the value of the additional field from the new file 240 for use in the additional field comparison, or (3) when the data chunk in the new file 240 is represented within the new file 240 using its hash value but not the value of the additional field, requesting the original content of the data chunk from the source data storage element 201 and then generating the value of the additional field based on the received original content of the data chunk for use in the additional field comparison. In at least some embodiments, in which a hash value of a data chunk and an additional field may be used to index the data chunk in the data chunk store 270 of the target data storage element 201, the following three cases may occur based on the comparison of the data chunk hash value and the comparison of the value of the additional field: (1) based on a determination that the data chunk hash values match but the values of the additional field for the data chunk do not match: insert the data chunk from the new file 240 into the data chunk store 270 of the target data storage element 201 (e.g., since there is no collision, because the data chunk hash value and the additional field are used to uniquely identify the data chunk), represent the data chunk in the new file in its encoded form (namely, a combination of the data chunk hash value and the value of the additional field) since the new file 240 can arrive at the target data storage element 201 in any form, update the data chunk store 270 of the target data storage element 201 to include both the data chunk hash value and the value of the additional field for the data chunk in the new file 240 (otherwise there is no way to reconstruct the data chunk); (2) based on a determination that the data chunk hash values match, the values of the additional field for the data chunk match, and the content of the data chunks is identical (e.g., based on a byte-by-byte comparison), which provides an indication that the data chunk included within the new file 240 already exists in the data chunk store 270 of the target data storage element 201, the following may be performed: represent the data chunk within the new file 240 in its encoded form (using a combination of the data chunk hash value and the value of the additional field, otherwise there is no way to reconstruct the data chunk), which may require processing of the new file 240 since the new file 240 can arrive at the target data storage element 201 in any form; and (3) based on a determination that the data chunk hash values match and the values of the additional field for the data chunk match but the content of the data chunks is not identical (e.g., based on a byte-by-byte comparison, the data chunk in the new file 240 (which may be in any form when the new file 240 is received, depending on the type of synchronization protocol being used) is represented in the new file 240 in the form of the original data (which may include replacing the hash value of the data chunk and the value of the additional field of the data chunk in the new file 240 with the original data chunk) and, further, the data chunk is not stored in the data chunk store 270 of the target data storage element 201 (i.e., the entry of the data chunk store 270 having the matching data chunk hash value and value of the additional field is not changed) since a hash collision has occurred.

In at least some embodiments, in which a file 240 is to be transferred from a source data storage element 201 to a target data storage element 201, a capability may be provided for handling the case in which an existing file on the target data storage element 201 has the same file name as the file 240 that is to be transferred. For example, this situation may be handled by a preventing transfer of the file 240 from the source data storage element 201 to the target data storage element 201, replacing the existing file 240 on the target data storage element 201 with the file 240 that is to be transferred from the source data storage element 201 to the target data storage element 201, transferring the file 240 from the source data storage element 201 to the target data storage element 201 but using a different file name when storing the file 240 on the target data storage element, or the like. It will be appreciated that, although primarily depicted and described with respect to embodiments in which data deduplication is performed for a single set of files of a single set of users, in at least some embodiments data deduplication may be performed for multiple sets of files of multiple sets of users, respectively.

In at least some embodiments, data deduplication may be applied on a per file set basis (and, thus, a per user set basis), such that duplication of data across user sets is not considered (e.g., data of family A and data of family B is not compared and processed in conjunction with each other, data of company A and data of company B is not compared and processed in conjunction with each other, or the like).

In at least some embodiments, data deduplication may be applied across files sets (and, thus, across user sets), such that duplication of data across user sets is considered (e.g., data of family A and data of family B may be compared and processed in conjunction with each other, data of company A and data of company B may be compared and processed in conjunction with each other, or the like). In at least some embodiments, a set of users may be given an option to indicate which, if any, of its files may be considered within the context of performing data deduplication across file sets. For example, a set of users may be willing to allow files that do not have personal information (e.g., audio files such as songs, video files such as television programs, or the like) to be used in conjunction with files of other sets of users to reduce data duplication. In at least some embodiments, a set of user may be incentivized to make files accessible for use in performing data deduplication of across file sets of user sets (e.g., reducing storage costs associated with files made available by the set of users, providing remuneration to the set of users based on level of redundancy reduction achieved through use of the files made available by the set of users, or the like, as well as various combinations thereof).

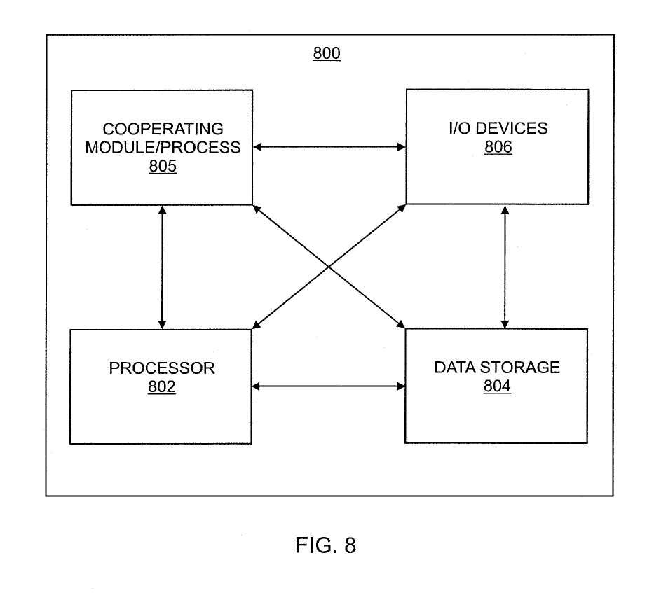

FIG. 8 depicts a high-level block diagram of a computer suitable for use in performing functions described herein.

The computer 800 includes a processor 802 (e.g., a central processing unit (CPU) or other suitable processor(s)) and a data storage 804 (e.g., memory (e.g., random access memory (RAM), read only memory (ROM), or the like), disk, or the like).

The computer 800 also may include a cooperating module/process 805. The cooperating process 805 can be loaded into data storage 804 (e.g., a memory portion of data storage 804) and executed by the processor 802 to implement functions as discussed herein and, thus, cooperating process 805 (including associated data structures) can be stored on a computer readable storage medium, e.g., RAM memory, magnetic or optical drive or diskette, and the like.

The computer 800 also may include one or more input or output devices 806 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 800 depicted in FIG. 8 provides a general architecture and functionality suitable for implementing functional elements described herein or portions of functional elements described herein. For example, computer 800 provides a general architecture and functionality suitable for implementing a DS 110, a portion of a DS 110, a CD 120, a portion of a CD 120, one or more elements of CN 130, a data storage element 201, a portion of data storage element 201, or the like.

It will be appreciated that the functions depicted and described herein may be implemented in hardware or a combination of software and hardware, e.g., using a general purpose computer, via execution of software on a general purpose computer so as to provide a special purpose computer, using one or more application specific integrated circuits (ASICs) or any other hardware equivalents, or the like, as well as various combinations thereof.

It will be appreciated that at least some of the method steps discussed herein may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods or techniques described herein are invoked or otherwise provided. Instructions for invoking the various methods may be stored in fixed or removable media, transmitted via a data stream in a broadcast or other signal bearing medium, or stored within a memory within a computing device operating according to the instructions.

It will be appreciated that the term “or” as used herein refers to a non-exclusive “or” unless otherwise indicated (e.g., via use of “or else” or “or in the alternative”).

It will be appreciated that, while the foregoing is directed to various embodiments of features present herein, other and further embodiments may be devised without departing from the basic scope thereof.

What is claimed is:

1. An apparatus, comprising:
a processor and a memory communicatively connected to the processor, the processor configured to:
receive a file comprising original file contents;
determine a set of data chunks of the original file contents of the file and a respective set of hash values of the data chunks;
determine whether the data chunks are stored in a data chunk store comprising a set of data chunks for one or more stored files;
encode the original file contents of the file, to form an encoded form of the original file contents of the file, based on the hash values of the data chunks;
compress the encoded form of the original file contents of the file to form a compressed and encoded form of the original file contents of the file; and
store the compressed and encoded form of the original file contents of the file.

2. The apparatus of claim 1, wherein the processor is configured to:
determine whether the original file contents of the file are stored locally; and
determine the set of data chunks, and the respective set of hash values of the data chunks, for the original file contents of the file based on a determination that the original file contents of the file are not stored locally.

3. The apparatus of claim 2, wherein the processor is configured to determine whether the original file contents of the file are stored locally based on at least one of:
a file size of the original file contents of the file; or
a hash value of the original file contents of the file.

4. The apparatus of claim 2, wherein the file is a first file having a first file size and a first file hash value associated therewith, wherein the processor is configured to determine whether the original file contents of the first file are stored locally by:
identifying a second file having original file contents associated therewith, wherein the original file contents of the second file have a second file size and a second file hash value associated therewith;
reconstructing the original file contents of the second file from a compressed and encoded form of the original file contents of the second file; and
performing a comparison of the original file contents of the first file and the original file contents of the second file.

5. The apparatus of claim 1, wherein the processor is configured to store the data chunks in the data chunk store by:
compressing the data chunks to form respective compressed forms of the data chunks; and
storing the compressed forms of the data chunks in the data chunk store with respective mappings to the hash values of the data chunks.

6. The apparatus of claim 1, wherein the processor is configured to:
store one of the data chunks of the original file contents of the file in the data chunk store based on a determination that the one of the data chunks of the original file contents of the file is not already stored in the data chunk store.

7. The apparatus of claim 1, wherein the processor is configured to encode the original file contents of the file to form the encoded form of the original file contents of the file by:
removing the data chunks from the original file contents of the file; and
inserting the hash values of the data chunks into the original file contents of the file.

8. The apparatus of claim 1, wherein the file further comprises metadata associated with the original file contents of the file, wherein the processor is configured to store the compressed and encoded form of the original file contents of the file by:
replacing the original file contents of the file with the compressed form of the encoded form of the original file contents of the file.

9. The apparatus of claim 1, wherein the file is a first file and the original file contents are first original file contents, wherein the processor is configured to:
receive a second file comprising second original file contents and metadata associated with the second original file contents; and
update the second file, based on a determination that the second original file contents of the second file are stored locally, by:
removing the second original file contents from the second file; and
inserting, into the second file, a reference to an existing file including original file contents identical to the second original file contents of the second file.

10. A method, comprising:
using a processor and a memory for:
receiving a file comprising original file contents;
determining a set of data chunks of the original file contents of the file and a respective set of hash values of the data chunks;
determining whether the data chunks are stored in a data chunk store comprising a set of data chunks for one or more stored files;
encoding the original file contents of the file, to form an encoded form of the original file contents of the file, by removing the data chunks from the file and inserting the associated hash values of the data chunks into the file;
compressing the encoded form of the original file contents of the file to form a compressed and encoded form of the original file contents of the file; and
storing the compressed and encoded form of the original file contents of the file.

11. An apparatus, comprising:
a processor and a memory communicatively connected to the processor, the processor configured to:
receive, from a data storage element, a file comprising metadata and file contents, wherein the file has original file contents associated therewith, wherein the original file contents comprise a set of data chunks; and
based on a determination that the file does not include a reference to a reference file comprising a form of the original file contents of the file, initiate a process to ensure that the set of data chunks of the original file contents of the file is present within a data chunk store comprising data chunks for one or more stored files.

12. The apparatus of claim 11, wherein the processor is configured to determine whether the file includes a reference to a reference file by at least one of:
searching the metadata of the file for a reference to a reference file; or
searching the file contents of the file for a reference to a reference file.

13. The apparatus of claim 11, wherein the file contents comprise a compressed form of an encoded form of the original file contents of the file, wherein the process to ensure that the set of data chunks of the original file contents of the file is available within the data chunk store comprises:
decompressing the compressed form of the encoded form of the original file contents of the file to recover the encoded form of the original file contents of the file;
identifying the set of data chunks of the original file contents of the file based on the encoded form of the original file contents of the file; and
determining availability, within the data chunk store, of the set of data chunks of the original file contents of the file.

14. The apparatus of claim 13, wherein, to determine availability, within the data chunk store, of the set of data chunks of the original file contents of the file, the processor is configured to:
determine a hash value of a data chunk of the set of data chunks of the original file contents of the file; and
search the data chunk store based on the hash value of the data chunk.

15. The apparatus of claim 13, wherein the processor is configured to:
based on a determination that a data chunk of the set of data chunks of the original file contents of the file is not available in the data chunk store:
propagate, toward the data storage element, a request for the data chunk of the set of data chunks of the original file contents of the file that is not available in the data chunk store;
receive the data chunk of the set of data chunks of the original file contents of the file that is not available in the data chunk store; and
update the data chunk store to include the data chunk of the set of data chunks of the original file contents of the file that is not available in the data chunk store.

16. The apparatus of claim 11, wherein the processor is configured to:
receive, from the data storage element, data chunk information associated with the file, wherein the data chunk information associated with the file comprises a set of data chunk hash values for the respective set of data chunks of the original file contents of the file.

17. The apparatus of claim 16, wherein the file contents of the file comprise a compressed form of an encoded form of the original file contents of the file, wherein the process to ensure availability of the set of data chunks of the original file contents of the file comprises:
identifying the set of data chunks of the original file contents of the file based on the data chunk information associated with the file; and
determining availability, within the data chunk store, of the set of data chunks of the original file contents of the file.

18. The apparatus of claim 17, wherein the processor is configured to:
based on a determination that a data chunk of the set of data chunks of the original file contents of the file is not available in the data chunk store:
propagate, toward the data storage element, a request for the data chunk of the set of data chunks of the original file contents of the file that is not available in the data chunk store;
receive the data chunk of the set of data chunks of the original file contents of the file that is not available in the data chunk store; and
update the data chunk store to include the data chunk of the set of data chunks of the original file contents of the file that is not available in the data chunk store.

19. The apparatus of claim 11, wherein the processor is configured to:
receive a second file from the data storage element, the second file having second original file contents associated therewith;
based on a determination that the second file includes a reference to a second reference file comprising a form of the second original file contents of the second file, propagate a request for the second reference file toward the data storage element.

20. The apparatus of claim 19, wherein the processor is configured to:
receive the second reference file from the data storage element; and
store the second reference file.
